(19) United States
(12) Patent Application Publication
(10) Pub. No.: US 2026/0236030 A1
(43) Pub. Date: Aug. 13, 2026

(54) INFORMATION PROCESSING METHOD AND APPARATUS, PROGRAM, AND INFORMATION PROCESSING SYSTEM

(71) Applicant: Sony Group Corporation, Tokyo (JP)

(72) Inventor: Yukiya SATO, Tokyo (JP)

(73) Assignee: Sony Group Corporation, Tokyo (JP)

(21) Appl. No.: 19/157,592

(22) PCT Filed: Mar. 1, 2024
(86) PCT No.: PCT/JP2024/007827

§ 371 Date: Aug. 18, 2025

(30) Foreign Application Priority Data
Mar. 22, 2023 (JP) 2023-044927

(51) Int. Cl. G05D 1/622; G05D 105/20; G05D 107/70; G05D 109/10; G05D 111/10; G06V 20/58

(52) U.S. Cl. CPC G05D 1/622; G06V 20/58; G05D 2105/20; G05D 2107/70; G05D 2109/10; G05D 2111/10

(57) ABSTRACT

The present disclosure relates to an information processing method and apparatus, a program, and an information processing system capable of suppressing a decrease in productivity due to obstacle avoidance.

The information processing apparatus acquires obstacle information indicating that a movable object arranged on a route of a mobile robot is detected as an obstacle, searches and determines an evacuation destination of the obstacle on the basis of productivity in a case where the obstacle is evacuated to a predetermined place, and presents the determined evacuation destination of the obstacle. The technology of the present disclosure can be applied to, for example, a mobile robot control system that controls a mobile robot.

### TECHNICAL FIELD

The present disclosure relates to an information processing method and apparatus, a program, and an information processing system, and more particularly, to an information processing method and apparatus, a program, and an information processing system capable of suppressing a decrease in productivity due to obstacle avoidance.

### BACKGROUND ART

A mobile robot such as an automated guided vehicle (AGV) autonomously moves in a space such as a factory or a warehouse on the basis of a route plan (movement route plan) formulated according to an assigned task. In a case where cargo or the like is temporarily placed on the movement route and becomes an obstacle and a state in which the mobile robot cannot pass through the planned route occurs, the mobile robot can reach the destination while avoiding the obstacle.

In the automobile field, there has been proposed a technique for reducing the influence of congestion by avoiding a bottleneck portion where congestion occurs (see, for example, Patent Documents 1 and 2).

### CITATION LIST

### Patent Document

Patent Document 1: Japanese Patent Application Laid-Open No. 2019-127194
Patent Document 2: WO 2020/249993 A

### SUMMARY OF THE INVENTION

### Problems to be Solved by the Invention

However, when the plurality of mobile robots moves while avoiding obstacles, the transport efficiency decreases, which causes a decrease in productivity.

The present disclosure has been made in view of such a situation, and an object thereof is to suppress a decrease in productivity due to obstacle avoidance.

### Solutions to Problems

An information processing method according to a first aspect of the present disclosure is
an information processing method including:
acquiring obstacle information indicating that a movable object arranged on a route of a mobile body is detected as an obstacle;
searching and determining an evacuation destination of the obstacle on the basis of productivity in a case where the obstacle is evacuated to a predetermined place; and
presenting a determined evacuation destination of the obstacle.

An information processing apparatus according to a first aspect of the present disclosure is
an information processing apparatus including:
an acquisition unit that acquires obstacle information indicating that a movable object arranged on a route of a mobile body is detected as an obstacle;
a determination unit that searches and determines an evacuation destination of the obstacle on the basis of productivity in a case where the obstacle is evacuated to a predetermined place; and
a presentation unit that presents a determined evacuation destination of the obstacle.

A program according to a first aspect of the present disclosure is
a program for causing a computer to execute processing of:
acquiring obstacle information indicating that a movable object arranged on a route of a mobile body is detected as an obstacle;
searching and determining an evacuation destination of the obstacle on the basis of productivity in a case where the obstacle is evacuated to a predetermined place; and
presenting a determined evacuation destination of the obstacle.

In the first aspect of the present disclosure, obstacle information indicating that a movable object arranged on a route of a mobile body is detected as an obstacle is acquired, an evacuation destination of the obstacle is searched and determined on the basis of productivity in a case where the obstacle is evacuated to a predetermined place, and the determined evacuation destination of the obstacle is presented.

An information processing system according to a second aspect of the present disclosure is
an information processing system including:
an information processing apparatus and a mobile body, in which
the mobile body includes:
a detection unit that detects a movable object disposed on a route of the mobile body as an obstacle; and
a transmission unit that transmits obstacle information indicating that the obstacle has been detected,
and
the information processing apparatus includes:
an acquisition unit that acquires the obstacle information;
a determination unit that searches and determines an evacuation destination of the obstacle on the basis of productivity in a case where the obstacle is evacuated to a predetermined place; and
a presentation unit that presents a determined evacuation destination of the obstacle.

In the second aspect of the present disclosure, in a mobile body, a movable object disposed on a route of the mobile body is detected as an obstacle, and obstacle information indicating that the obstacle has been detected is transmitted. In the information processing apparatus, the obstacle information is acquired, an evacuation destination of the obstacle is searched and determined on the basis of productivity in a case where the obstacle is evacuated to a predetermined place, and the determined evacuation destination of the obstacle is presented.

The program can be provided by being transmitted via a transmission medium or by being recorded on a recording medium.

The information processing apparatus may be an independent apparatus or an internal block constituting one apparatus.

### BRIEF DESCRIPTION OF DRAWINGS

FIG. 1 is a diagram illustrating an example in which a real space in a factory is converted into a route graph.

FIG. 2 is a diagram illustrating an example in which a node is occupied by a temporary obstacle.

FIG. 3 is a diagram illustrating a difference in a movement route depending on the presence or absence of a temporary obstacle.

FIG. 4 is a block diagram illustrating a configuration example of a first embodiment of a mobile robot control system which is an information processing system of the present disclosure.

FIG. 5 is a diagram for explaining a situation in which the mobile robot detects an obstacle while moving.

FIG. 6 is a diagram illustrating a difference between a route bypassing an obstacle and a route in a case where the obstacle is evacuated.

FIG. 7 is a diagram illustrating an example of an evacuation destination presentation screen displayed on a UI unit.

FIG. 8 is a diagram illustrating an example of inputting presence or absence of an obstacle on the evacuation destination presentation screen.

FIG. 9 is a flowchart for explaining obstacle evacuation presentation processing.

FIG. 10 is a diagram for explaining a modification of the first embodiment.

FIG. 11 is a diagram illustrating an example of an operation state screen of the mobile robot.

FIG. 12 is a block diagram illustrating a configuration example of a second embodiment of a mobile robot control system which is an information processing system of the present disclosure.

FIG. 13 is a diagram illustrating an example in which object recognition processing is executed on a captured image.

FIG. 14 is a flowchart for explaining evacuation destination search necessity determination processing.

FIG. 15 is a diagram illustrating an example of an evacuation destination presentation screen according to the second embodiment.

FIG. 16 is a diagram illustrating an example of conversion from a real space in a factory to a route graph.

FIG. 17 is a diagram illustrating an example of a route graph in a case where a chair can be moved.

FIG. 18 is a flowchart for explaining layout change presentation processing.

FIG. 19 is a block diagram illustrating a configuration example of an embodiment of a computer to which the technology of the present disclosure is applied.

### MODE FOR CARRYING OUT THE INVENTION

Hereinafter, modes for carrying out the technology of the present disclosure (hereinafter, referred to as embodiments) will be described with reference to the accompanying drawings. Note that, in the present specification and the drawings, components having substantially the same functional configuration are denoted by the same reference signs, and redundant description is omitted. The description will be given in the following order.
1. Overview of Mobile Robot Control
2. First Embodiment of Mobile Robot Control System
3. Control Example of Mobile Robot Control System
4. Flowchart of Obstacle Evacuation Presentation Processing
5. Modification of First Embodiment
6. Second Embodiment of Mobile Robot Control System
7. Flowchart of Evacuation Destination Search Necessity Determination Processing
8. Graph Layout Change Presentation Function Using Object Recognition Processing
9. Flowchart of Layout Change Presentation Processing
10. Modification of Second Embodiment
11. Summary
12. Configuration Example of Hardware of Computer

### 1. Overview of Mobile Robot Control

Before describing the technology of the present disclosure, an overview of transport control by a plurality of mobile robots will be described.

For example, a mobile robot such as an automated guided vehicle (AGV) is used to transport a workpiece, a raw material, or the like in a manufacturing factory or transport a part, a product, a raw material, or the like in a warehouse. The mobile robot autonomously moves in a space such as a factory or a warehouse on the basis of a route plan (movement route plan) formulated according to the assigned task. The mobile robot is not limited to one that transports some article, and for example, there is one that moves for cleaning or for monitoring.

Since it is expensive to plan a route for causing a plurality of mobile robots to reach a destination without colliding with each other in a real space where the stop location and the relevance between the stop locations are not explicit, it is possible to plan the routes of the plurality of mobile robots within a time that can withstand actual operation by changing the real space to graph representation. A control system that controls a plurality of mobile robots converts a real space in which the mobile robot is movable into a graph representation (hereinafter, also referred to as a route graph) including nodes and edges, and controls movement and stop of the mobile robot on a route graph. The route graph is generally designed by a human hand or is created by being reworked by a human after being automatically converted from space map information into a graph representation. A node in the route graph represents a place where the mobile robot can stop, and an edge represents a route (movement route) connecting the nodes and on which the mobile robot can move.

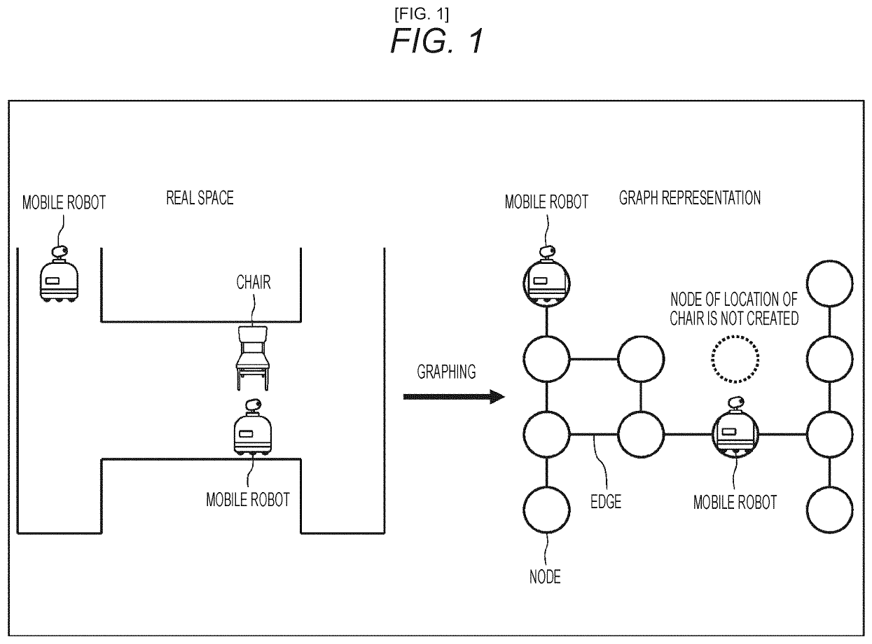

FIG. 1 illustrates an example in which a real space in a factory is converted into a route graph.

The route graph is reworked and created by a person so as to avoid a place where cargo is regularly placed in a factory or a place where the mobile robot does not want to pass. In the example of FIG. 1, the route graph is modified so that no node is created at the place where the chair is regularly placed.

The management server makes a route plan from the departure point to the destination on the basis of the task assigned to each mobile robot, and instructs each mobile robot. For example, in a case where the task assigned to the mobile robot is component transport, the component receiving location is set as the destination. Each mobile robot grasps which node or edge on the route graph the mobile robot is located from the information acquired by the sensor in the apparatus, and transmits the position information of the mobile robot to the management server. The management server aggregates the position information of each mobile robot and manages the timing of stopping at each node or passing through an edge.

In actual operation, not all nodes on the route graph are always accessible. The cause of hindering the passage is due to a difference in environment between the time of design and the time of actual operation, and for example, when a temporary obstacle is installed on a node through which the mobile robot passes, the mobile robot may not be able to move along the planned route.

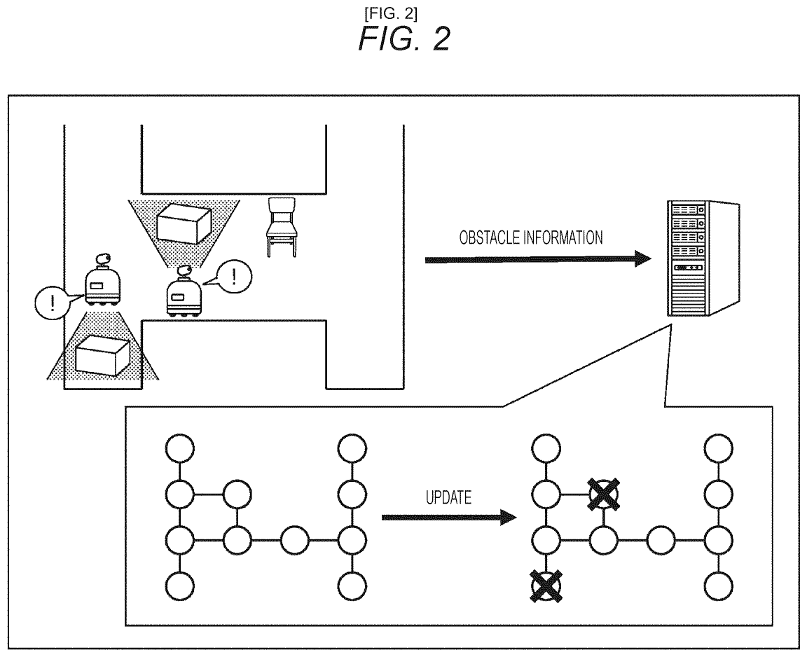

For example, as illustrated in FIG. 2, cargo may be temporarily placed on a route in a factory. The mobile robot cannot pass through the nodes and edges occupied by the cargo. The mobile robot detects the temporarily placed cargo as an obstacle from the information acquired by the sensor, and notifies the management server of obstacle information indicating that the obstacle has been detected. The management server prohibits entry into the node occupied by the obstacle, updates the route graph, and replans the route of each mobile robot with the updated route graph. By dynamically updating the route graph by detecting a node that cannot pass in the system in this manner, it is possible to cause a plurality of mobile robots to reach a destination while avoiding obstacles by reflecting the influence of the obstacles temporarily occupying the nodes.

According to the above method, the temporarily placed obstacles are detected and reflected in the route graph, and the mobile robots can reach the destination without colliding with each other while avoiding the obstacles. However, reducing the number of nodes in the route graph causes a decrease in the transport efficiency of the mobile robot, which in turn causes a decrease in the productivity of the factory. In general, a large number of nodes on the route graph increases the degree of freedom of movement of each mobile robot, and shortens the time for each mobile robot to reach the destination while avoiding collision with each other. The occurrence of an obstacle on the route lowers the degree of freedom of movement of the mobile robot, causing a decrease in transport efficiency.

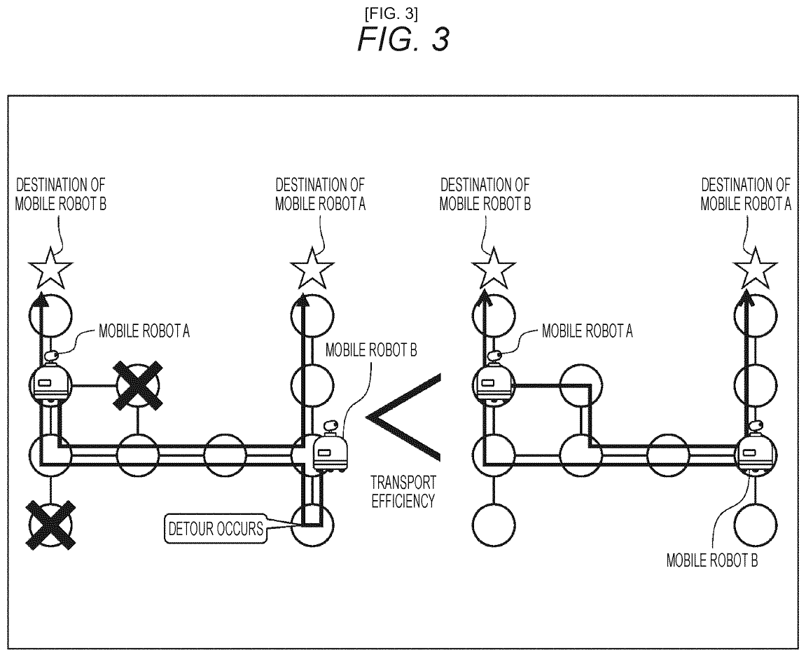

FIG. 3 illustrates a difference in the movement route depending on the presence or absence of a temporary obstacle in the example illustrated in FIG. 2.

A route graph on the right side of FIG. 3 illustrates a movement route according to the route plan before the cargo is placed, and a route graph on the left side illustrates a movement route according to the route plan after the cargo is placed. Movement to the two nodes is restricted due to the cargo being placed. In the route plan before the cargo is placed, the mobile robot A and the mobile robot B pass through different routes, so that the mobile robot A and the mobile robot B can reach the destination without colliding with each other. When the movement of the mobile robot B to the two nodes is restricted by the cargo, the mobile robot B needs to retreat to a node to which the mobile robot B does not originally need to move in order to avoid a collision, and needs to travel in a detour. That is, the transport efficiency is reduced due to the temporarily placed obstacles. This decrease in transport efficiency is caused by generation of a bottleneck portion where it is difficult for a plurality of mobile robots to pass without colliding with each other due to generation of an obstacle, and a congestion of the mobile robots is caused.

In order to avoid the congestion caused by the bottleneck, the system of the present disclosure described below does not reduce the influence of the congestion by each mobile robot, but alleviates the congestion by proposing a change of the layout itself that is causing the bottleneck. This suppresses a decrease in transport efficiency and a decrease in productivity.

Note that, in the following embodiments, a case where the mobile robot is a transport apparatus that transports a workpiece, a part, or the like is taken as an example, and the efficiency of movement may be expressed as transport efficiency. However, as described above, some mobile robots move to perform cleaning or move for the purpose of monitoring, and the present invention is not limited to the case of transporting an object. More generally speaking, the system of the present disclosure can suppress a decrease in movement efficiency of the mobile robot and a decrease in productivity.

In the following embodiments, for the sake of simplicity, it is described that the obstacles are disposed at locations on the nodes on the route graph configured by the nodes and the edges, but the mobile robots can be similarly controlled in a case where the obstacles are disposed at locations on the edges.

### 2. First Embodiment of Mobile Robot Control System

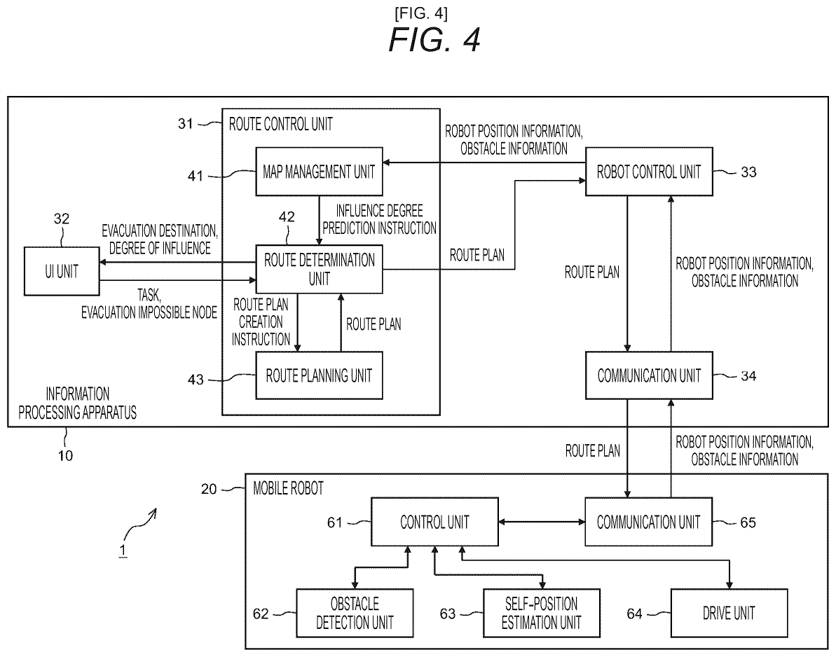

FIG. 4 is a block diagram illustrating a configuration example of a first embodiment of a mobile robot control system which is an information processing system of the present disclosure.

The mobile robot control system 1 in FIG. 4 includes an information processing apparatus 10 and a plurality of mobile robots 20. In FIG. 4, only the configuration of one mobile robot 20 is illustrated due to paper constraints. The mobile robot 20 is a mobile body capable of autonomous movement, and typical examples thereof include an AGV (automated guided vehicle) that moves in a factory and transports a workpiece in the middle of manufacturing, and a forklift that moves in a warehouse and transports a part or a finished product. The information processing apparatus 10 and each mobile robot 20 are connected to a predetermined network such as a local area network (LAN) or a wide area network (WAN), and can communicate with each other wirelessly.

The information processing apparatus 10 is a management apparatus that manages the operation of each mobile robot 20, and performs assignment of a task to each mobile robot 20, execution of route planning of each mobile robot 20, and the like. The information processing apparatus 10 can be configured by, for example, a server apparatus, a personal computer, a notebook computer, a tablet, a smartphone, or the like. The mobile robot 20 acquires a route plan to a destination determined according to a task assigned to the mobile robot 20 from the information processing apparatus 10, and autonomously moves to transport a transport object such as a workpiece, a raw material, or a part to the destination.

The information processing apparatus 10 includes a route control unit 31, a UI unit 32, a robot control unit 33, and a communication unit 34.

The destination of each mobile robot 20 is determined by assigning a task to each mobile robot 20. The route control unit 31 acquires the position information of each mobile robot 20, executes the route plan of each mobile robot 20, and determines the movement route to the destination. In a case where the route control unit 31 acquires, from the robot control unit 33, obstacle information that is information regarding an obstacle on a movement route detected by each mobile robot 20, the route plan is reviewed according to the obstacle information.

The route control unit 31 is a control unit that controls the movement route of the mobile robot 20, and includes a map management unit 41, a route determination unit 42, and a route planning unit 43.

The map management unit 41 converts the real space in which the mobile robot 20 can move into a route graph and holds the route graph. The map management unit 41 acquires the position information of each mobile robot 20 from the robot control unit 33, and grasps the passage situation of each mobile robot 20 on the route graph. In addition, the map management unit 41 acquires obstacle information indicating that each mobile robot 20 has detected an obstacle, and manages the passability information of each node of the route graph. Specifically, the map management unit 41 changes (controls) validity or invalidity of a node on the route graph according to the detected obstacle. In the present embodiment, an obstacle refers to a movable object that is temporarily placed on a route graph set to be passable, thereby obstructing passage of the mobile robot 20. Therefore, the obstacle here does not include a fixed obstacle recognized at the time of designing the route graph, for example, a column in a building or a fixed shelf. In a case where a change occurs in the route graph due to the occurrence of an obstacle, the map management unit 41 instructs the route determination unit 42 to predict the degree of influence of the obstacle on the route graph on the productivity.

The task assigned to the mobile robot 20 and input by the user (operator) is supplied from the UI unit 32 to the route determination unit 42. The route determination unit 42 instructs the route planning unit 43 to create a route plan for each mobile robot 20 to execute the task using the current route graph as the initial state. The route determination unit 42 acquires the route plan created by the route planning unit 43, determines a route along which the mobile robots 20 reach the destination without colliding with each other, supplies the route to the robot control unit 33, and causes the mobile robots 20 to transmit the route plan.

In addition, in a case where a new obstacle is detected in a predetermined node on the route graph and an influence degree prediction instruction is supplied from the map management unit 41, the route determination unit 42 predicts the influence degree of the obstacle placed on the route graph on the productivity. In addition, the route determination unit 42 predicts whether or not the degree of influence on the productivity is improved in a case where the obstacle placed on the route graph is moved to another node as the evacuation destination.

The index of productivity varies depending on the task executed by the mobile robot 20. For example, in a case where the task is a task of transporting an article, the index of the productivity can be represented by an arrival time which is a time until the mobile robot 20 arrives at the destination, a conveyance amount of the article per unit time, or the like. Furthermore, for example, in a case where the task is a task to be monitored, the index of productivity can be represented by the number of nodes indicating how many nodes on the route graph can be covered per unit time. In the present embodiment, the index of productivity is represented by “throughput” representing the number of times the mobile robot 20 reaches the destination per unit time. Regarding the productivity, for example, a target value is determined in advance on the basis of an operation target of a factory or the like, and the degree of influence on the productivity is represented by a change amount of the productivity such as a difference (shortage amount or increase amount) from the target value or a difference (decrease amount or increase amount) from the productivity by a route plan before the occurrence of an obstacle.

The route determination unit 42 instructs the route planning unit 43 to create a route plan using the route graph updated by the new obstacle, and acquires the created route plan from the route planning unit 43. The route determination unit 42 calculates a throughput, which is an index of productivity, on the basis of a route plan using a route graph reflecting the detected new obstacle. In a case where the calculated throughput is less than the target value (hereinafter, also referred to as a target throughput), the route determination unit 42 calculates the degree of influence on the productivity, that is, how much the throughput is improved in a case where the new obstacle is moved to the evacuation destination of another node. The route plan in a case where the new obstacle is moved to the evacuation destination is instructed to the route planning unit 43 and supplied from the route planning unit 43. In a case where throughput is improved by moving a new obstacle to an evacuation destination of another node, the route determination unit 42 determines a proposed evacuation destination to be proposed as an evacuation destination of an obstacle for improving productivity. The route determination unit 42 supplies the determined proposed evacuation destination to the UI unit 32 together with the degree of influence.

Note that there may be a case where it is not possible to actually retreat, for example, other cargo or the like is placed in the determined proposed evacuation destination. In a case where the proposed evacuation destination is a node that cannot be evacuated, the evacuation impossible node information indicating that the proposed evacuation destination is the evacuation impossible node is supplied from the UI unit 32 to the route determination unit 42. In this case, the route determination unit 42 excludes the evacuation to the evacuation impossible node from the evacuation destination candidates.

The route planning unit 43 creates a route plan on the basis of the instruction to create a route plan from the route determination unit 42. The created route plan is supplied to the route determination unit 42.

The UI unit 32 is a user interface for a user who is an operator of the mobile robot control system 1 to perform input and output with respect to the mobile robot control system 1, and includes, for example, a keyboard, a mouse, a display, and the like. The UI unit 32 displays a task input screen for inputting a task to be assigned to the mobile robot 20, and supplies a task input by the user for each mobile robot 20 to the route determination unit 42. In addition, in a case where the evacuation destination and the degree of influence to be proposed for the newly detected obstacle are supplied from the route determination unit 42, the UI unit 32 displays an evacuation destination presentation screen displaying the evacuation destination and the degree of influence. The UI unit 32 functions as a presentation unit that presents an evacuation destination H an obstacle. In a case where a predetermined node on the route graph is an evacuation impossible node, the user can input (instruct) that the node is an evacuation impossible node on the evacuation destination presentation screen. In a case where it is input that the node is an evacuation impossible node, the UI unit 32 supplies the route determination unit 42 with evacuation impossible node information indicating that the node is an evacuation impossible node.

The UI unit 32 may be a touch panel display having a touch input function. Furthermore, the UI unit 32 may include a portable terminal such as a smartphone or a tablet, may be configured as an apparatus different from the information processing apparatus 10, and may communicate with the route determination unit 42 by wireless communication such as a wireless LAN.

The robot control unit 33 is a control unit that controls the mobile robot 20 via the communication unit 34. The robot control unit 33 transmits the route plan of the mobile robot 20 supplied from the route determination unit 42 to the mobile robot 20 to be controlled via the communication unit 34. The robot control unit 33 acquires the position information of the mobile robot 20 periodically supplied from each mobile robot 20 via the communication unit 34, and supplies the position information to the map management unit 41. In a case where the mobile robot 20 detects an obstacle on the route graph and transmits obstacle information to the information processing apparatus 10, the robot control unit 33 acquires the obstacle information from the mobile robot 20 via the communication unit 34 and supplies the obstacle information to the map management unit 41.

The communication unit 34 is a communication module that is connected to a predetermined network such as a local area network (LAN) or a wide area network (WAN) and communicates with another apparatus connected to the network. The communication can be wireless communication using Bluetooth (registered trademark), Wi-Fi (trademark), or the like, and may be communication in which wireless communication and wired communication are mixed.

The mobile robot 20 includes a control unit 61, an obstacle detection unit 62, a self-position estimation unit 63, a drive unit 64, and a communication unit 65.

The control unit 61 controls the entire operation of the mobile robot 20. In a case where the route plan is transmitted from the information processing apparatus 10 via the communication unit 65, the control unit 61 controls each unit of the mobile robot 20 to arrive at the destination according to the route plan. For example, in a case where the obstacle information indicating that the obstacle on the movement route has been detected is supplied from the obstacle detection unit 62, the control unit 61 transmits the obstacle information to the information processing apparatus 10 via the communication unit 65. The control unit 61 transmits the self-position (the position of the mobile robot 20) supplied from the self-position estimation unit 63 as its own position information to the information processing apparatus 10 via the communication unit 65. The control unit 61 determines its own moving direction on the basis of the route plan, the obstacle information, and the self-position information, and controls the drive unit 64.

The obstacle detection unit 62 includes, for example, a stereo camera having two imaging sensors, and generates a captured image obtained by imaging a subject and a depth image obtained by detecting a distance to an object to detect an object to be an obstacle. Alternatively, the obstacle detection unit 62 may include a distance measuring module such as light detection and ranging (LiDAR), for example, and may detect an object to be an obstacle by irradiating the periphery of the apparatus with measurement light and measuring the distance to the object by receiving reflected light that is reflected and returned. In a case of detecting an obstacle on the movement route, the obstacle detection unit 62 supplies obstacle information regarding the obstacle to the control unit 61. The obstacle information includes at least position information of the obstacle.

The self-position estimation unit 63 estimates the self-position on the basis of information on the movement route supplied from the control unit 61, obstacle information around the self-position detected by the obstacle detection unit 62, measurement information from an inertial measurement unit (IMU) (not illustrated), and the like. The mobile robot 20 may include an imaging sensor, and the self-position estimation unit 63 may estimate the self-position by visual simultaneous localization and mapping (Visual-SLAM). The mobile robot 20 may include a positioning sensor that receives a signal from a global navigation satellite system (GNSS) such as a global positioning system (GPS), and may estimate the self-position on the basis of a sensor signal of the positioning sensor. The self-position estimation unit 63 supplies information indicating the estimated self-position to the control unit 61.

The drive unit 64 includes one or a plurality of motors as a moving mechanism, and drives the motors on the basis of a drive signal supplied from the control unit 61 to move the mobile robot 20.

The communication unit 65 includes a communication module similar to that of the communication unit 34 of the information processing apparatus 10, and performs communication by the same communication scheme as that of the information processing apparatus 10 according to an instruction from the control unit 61. For example, the communication unit 65 transmits its own position information and obstacle information on an obstacle detected on the route graph, which are supplied from the control unit 61, to the information processing apparatus 10. Furthermore, the communication unit 65 receives its own route plan transmitted from the information processing apparatus 10 and supplies the route plan to the control unit 61.

The information processing apparatus 10 and the mobile robot 20 are configured as described above.

The mobile robot 20 moves toward the destination on the basis of the route plan supplied from the information processing apparatus 10, and sequentially transmits its own position information to the information processing apparatus 10. In a case of detecting an obstacle in the processing of moving to the destination, the mobile robot 20 transmits obstacle information to the information processing apparatus 10.

In a case where the obstacle information is supplied from the mobile robot 20, the map management unit 41 of the information processing apparatus 10 invalidates the node on the route graph according to the detected obstacle, and instructs the route determination unit 42 to predict the influence degree of the obstacle on the productivity on the route graph.

On the basis of the influence degree prediction instruction from the map management unit 41, the route determination unit 42 predicts the influence degree of the obstacle newly detected on the route graph on the productivity. In addition, the route determination unit 42 predicts whether or not the degree of influence on the productivity is improved in a case where the obstacle placed on the route graph is moved to another node as the evacuation destination. More specifically, the route determination unit 42 causes the route planning unit 43 to create a route plan while virtually switching the presence or absence of an obstacle on the assumption that the obstacle is moved to the evacuation destination, and quantitatively evaluates the degree of influence of productivity. In a case where the productivity is improved by moving the newly detected obstacle to the evacuation destination, the route determination unit 42 supplies the evacuation destination of the obstacle for improving the productivity and the degree of influence in a case where the obstacle is evacuated to the evacuation destination to the UI unit 32. The UI unit 32 displays an evacuation destination presentation screen that proposes the user to move the obstacle to the evacuation destination. By moving the obstacle to the evacuation destination, the user viewing the evacuation destination presentation screen can minimize a decrease in productivity without the mobile robot 20 performing bypassing or the like due to the obstacle. That is, it is possible to suppress a decrease in productivity due to obstacle avoidance.

### 3. Control Example of Mobile Robot Control System

Hereinafter, the control of the mobile robot control system 1 will be described more specifically with reference to the drawings.

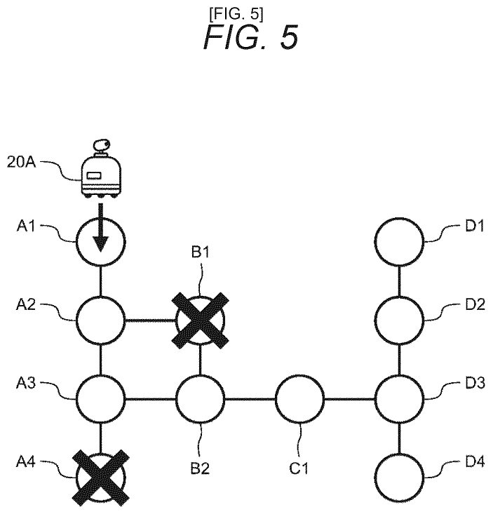

FIG. 5 is a diagram for explaining a situation where a predetermined one mobile robot 20A of the plurality of mobile robots 20 detects an obstacle while moving.

The route graph of FIG. 5 is configured in accordance with the real space of the factory illustrated in FIG. 1. The route graph includes the nodes A1 to A4, the nodes B1 and B2, the node C1, and the nodes D1 to D4, and edges connecting front, rear, left, and right nodes. Obstacles are placed on the node B1 and the node A4, and the mobile robot 20 cannot pass therethrough. However, the information processing apparatus 10 has not yet recognized that there are obstacles on the node B1 and the node A4. In such a state, at the timing when the mobile robot 20A enters the node A1 and passes through the node A1, an obstacle placed at the node B1 is detected, and the obstacle information is transmitted to the information processing apparatus 10. At the time of passing through the node A1, an obstacle of the node A4 has not yet been detected.

The route control unit 31 of the information processing apparatus 10 predicts the degree of influence of the obstacle placed on the node B1 on the productivity. In the present embodiment, since the index of productivity is represented by a throughput, the route control unit 31 calculates a throughput in a case where there is an obstacle in the node B1 and the obstacle is not evacuated and a passage that avoids a movement route is performed. In a case where the throughput in a case where the movement route to bypass without evacuating the obstacle of the node B1 is selected does not fall below the target throughput, it is not necessary to notify the user of the evacuation destination without examining the evacuation destination.

On the other hand, in a case where the throughput in a case where the route of bypassing without evacuating the obstacle of the node B1 is selected is lower than the target throughput, the evacuation destination of the obstacle is examined in order to improve the productivity. Specifically, the route control unit 31 sequentially sets (assumes) all the nodes available as the evacuation destinations of the obstacle of the node B1 in the nodes on the route graph as the evacuation candidate nodes, calculates the throughput in a case where the obstacle is evacuated to the evacuation candidate nodes, and determines the evacuation candidate node having the largest throughput increase as the evacuation destination of the obstacle. In a case where a plurality of evacuation candidate nodes whose throughput increases by a predetermined value or more is detected, a plurality of evacuation destinations may be determined. Alternatively, a threshold for presenting the evacuation destination may be set, and the evacuation destination of the obstacle may be determined only in a case where the increase in the throughput is equal to or greater than a predetermined threshold.

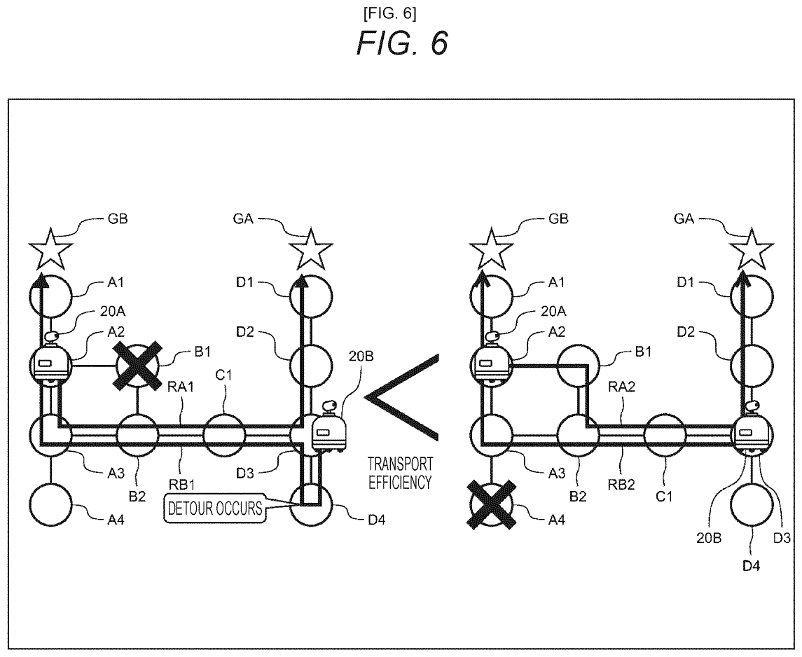

FIG. 6 illustrates an example of a route in a case where a route to bypass without evacuating the obstacle of the node B1 is selected and in a case where the evacuation candidate node is the node A4.

A route graph on the left side of FIG. 6 illustrates a movement route calculated in the route plan in a case where the obstacle of the node Bl is not evacuated. The route graph on the right side indicates the movement route calculated in the route plan in a case where the obstacle of the node B1 is evacuated to the node A4. The mobile robot 20B is another mobile robot 20 passing through a similar route at a timing similar to the mobile robot 20A.

In a case where the obstacle at the node B1 is not evacuated, the route plan for the mobile robot 20A to move from the node A2 in the direction of the destination GA through the route RAI is calculated. For the mobile robot 20B, a route plan for passing through the route RB1 from the node D3 and moving in the direction of the destination GB is calculated. In order to avoid collision with the mobile robot 20A, the mobile robot 20B needs to temporarily retreat to the node D4, which is a detour route.

On the other hand, in a case where the obstacle at the node B1 is evacuated to the node A4, the route plan for the mobile robot 20A to move from the node A2 toward the destination GA through the route RA2 is calculated. For the mobile robot 20B, a route plan for passing through the route RB2 from the node D3 and moving in the direction of the destination GB is calculated. As the mobile robot 20A moves via the node B1 and the mobile robot 20B moves via the node A3, an efficient route is achieved while avoiding collision.

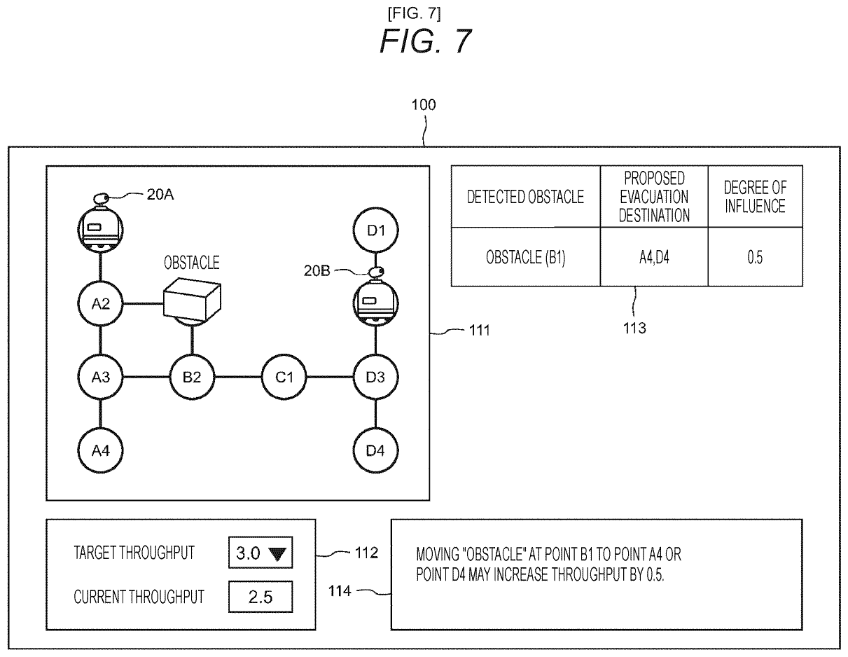

FIG. 7 illustrates an example of an evacuation destination presentation screen displayed on the UI unit 32 in a case where the node A4 and the node D4 are determined as the proposed evacuation destinations of the obstacle of the node B1.

The evacuation destination presentation screen 100 illustrated in FIG. 7 includes a route graph display unit 111, a throughput display unit 112, a proposed evacuation destination display unit 113, and a comment display unit 114.

The route graph display unit 111 displays a situation in which an obstacle has been detected on the route graph. The route graph display unit 111 displays the detected obstacle and the mobile robots 20A and 20B, which are the mobile robots 20 affected by the obstacle, on the route graph.

The throughput display unit 112 displays the target throughput and the current throughput. The target throughput is a target value of the throughput adopted as an index of productivity, and the current throughput is a throughput in a case where the detected obstacle is not evacuated. For the item of the target throughput, for example, the user can set the target value by a pull-down menu.

The proposed evacuation destination display unit 113 displays the detected obstacle, the proposed evacuation destination, and the degree of influence in a case where the obstacle is evacuated to the proposed evacuation destination. In the example of FIG. 7, “obstacle (B1)” indicating that the obstacle is the obstacle of the node Bl is displayed as the detected obstacle, nodes “A4” and “D4” are displayed as the proposed evacuation destinations, and “0.5” is displayed as the degree of influence in a case where the obstacle is evacuated to the node A4 or the node D4.

The comment display unit 114 displays a comment for explaining the proposal content on the evacuation destination presentation screen 100. In the example of FIG. 7, “Moving the “obstacle” at point B1 to point A4 or point D4 may increase throughput by 0.5.” is displayed, and the action to be taken by the user and the effect thereof are displayed.

The user checks the evacuation destination presentation screen 100 displayed on the UI unit 32, and in a case where it is possible to move the obstacle at the point Bl to the point A4 or the point D4, the user performs work of moving the obstacle to the point A4 or the point D4. As a result, a detour route such as the route RB1 on the left side of FIG. 6 can be avoided, and productivity can be improved. That is, it is possible to suppress a decrease in productivity due to obstacle avoidance.

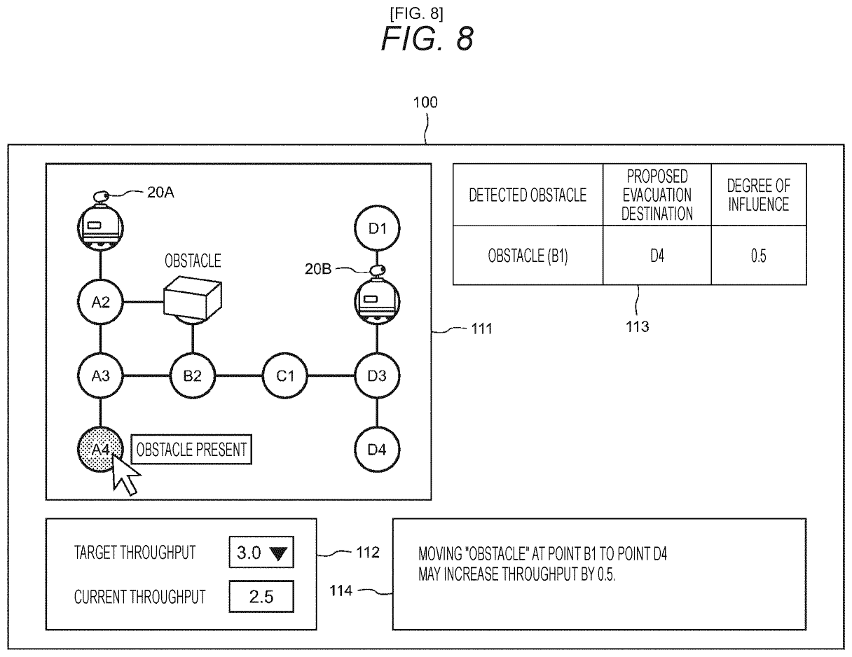

Meanwhile, as described with reference to FIG. 5, there is a case where another cargo is placed at the point A4 and the obstacle at the point B1 cannot be moved to the point A4. In a case where the user who has checked the evacuation destination presentation screen 100 recognizes that another cargo is placed at the point A4 and the obstacle at the point B1 cannot be moved to the point A4, the user can input availability of the evacuation destination of each node on the evacuation destination presentation screen 100. For example, as illustrated in FIG. 8, the presence or absence of an obstacle can be input by clicking (selecting) each node of the route graph display unit 111. The user specifies that there is an obstacle in the node A4 by clicking the node A4.

In a case where the node A4 of the route graph display unit 111 is clicked on the evacuation destination presentation screen 100 and it is input that the node A4 cannot be adopted as the evacuation destination due to the presence of an obstacle, the UI unit 32 supplies the route determination unit 42 with the evacuation impossible node information indicating that the node A4 is an evacuation impossible node. The route determination unit 42 excludes the node A4 from the evacuation destination candidates and displays an evacuation destination presentation screen 100 displaying other evacuation destinations. In the example of FIG. 8, since it is input that the node A4 cannot be adopted as the evacuation destinations, the proposal evacuation destinations of the proposed evacuation destination display unit 113 and the comment display unit 114 are changed only to the point D4.

Meanwhile, in a case where another cargo is placed at the point A4, the mobile robot 20A that has moved may be detected as a new obstacle instead of the input of the evacuation impossible node by the user. In this case, the mobile robot 20A detects an obstacle placed on the node A4, and transmits the obstacle information to the information processing apparatus 10. The validity or invalidity of the node of the route graph held by the map management unit 41 of the information processing apparatus 10 is updated (changed). The route determination unit 42 predicts the degree of influence of the obstacle placed on the node B1 on the productivity by using the updated route graph, and displays an evacuation destination presentation screen 100 that excludes the node A4 from the evacuation destination candidates and presents only the D4 point as the proposed evacuation destination, for example, as illustrated in FIG. 8.

As described above, the mobile robot 20 detects an obstacle while moving, and every time a new obstacle is detected, the update of the route graph, the evaluation of the throughput (productivity), and the search and proposal of the evacuation destination in a case where the throughput is lower than the target throughput are executed, whereby the obstacle can be avoided and the decrease in productivity can be suppressed.

### Method for Detecting Obstacle on Route Graph

In the example described above, as a method by which the information processing apparatus 10 detects that an obstacle is placed on a predetermined node on the route graph, there are a method of detecting by acquiring obstacle information detected and transmitted by the mobile robot 20 that is moving, and a method in which the user designates the predetermined node as an evacuation impossible node on the evacuation destination presentation screen 100.

However, since the information processing apparatus 10 only needs to be able to detect that a predetermined node is an evacuation impossible node, for example, the information processing apparatus 10 may acquire a captured image captured by a monitoring camera or the like installed in a factory, detect that an obstacle is placed on the predetermined node, and update information on whether or not the predetermined node is an evacuation impossible node. In this case, the obstacle information can be acquired with more real time, and the current route graph can be updated.

### Evacuation of Obstacle Outside Route Graph

Depending on the type of the obstacle, it is conceivable that the obstacle can be moved to a location outside the route graph, instead of other nodes on the route graph. For example, in a case where the route graph is a graph of a passage in a factory, it may be possible to move cargo such as a part outside the factory or to a shelf other than the passage in the factory. In such a case, the influence degree of productivity assuming a case where the obstacle is evacuated outside the route graph may be predicted and proposed to the user.

### 4. Flowchart of Obstacle Evacuation Presentation Processing

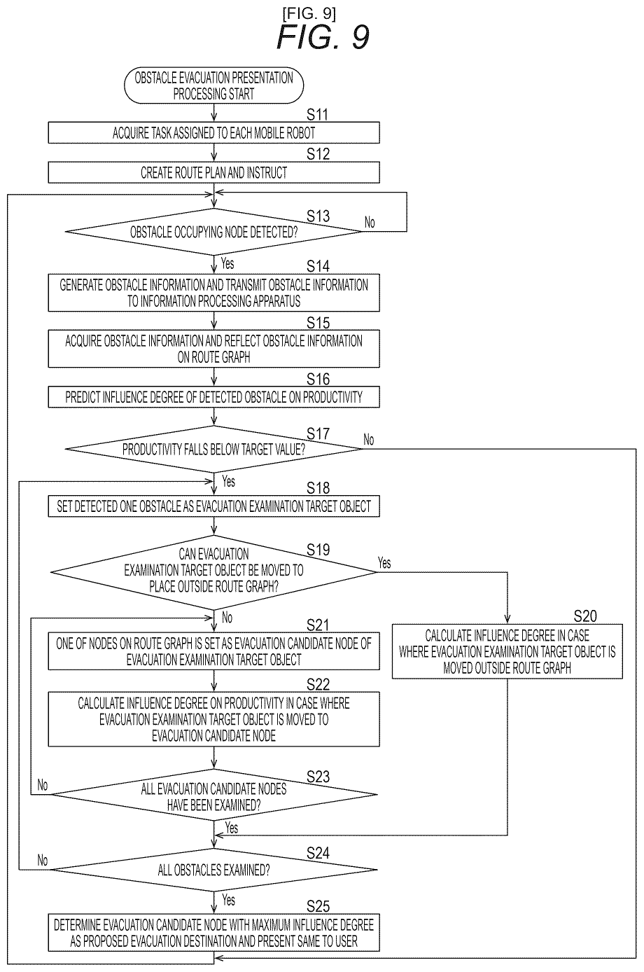

Obstacle evacuation presentation processing for presenting an evacuation destination of an obstacle detected on a movement route, which is executed by the mobile robot control system 1, will be described with reference to a flowchart of FIG. 9. This processing is started, for example, when an operation for starting control of the mobile robot 20 is performed in the mobile robot control system 1.

First, in step S11, the UI unit 32 displays a task input screen, acquires a task assigned to each mobile robot 20 on the task input screen, and supplies the task to the route determination unit 42.

In step S12, the route control unit 31 creates a route plan for the mobile robot 20 to which the task is assigned, and instructs each mobile robot 20 via the robot control unit 33. More specifically, the route determination unit 42 instructs the route planning unit 43 to create a route plan for the mobile robot 20 to which the task is assigned, using the current route graph. The route planning unit 43 creates a route plan on the basis of the instruction to create a route plan from the route determination unit 42, and supplies the route plan to the route determination unit 42. The route determination unit 42 acquires the route plan created by the route planning unit 43, determines a route along which the mobile robots 20 reach the destination without colliding with each other, supplies the route to the robot control unit 33, and causes the mobile robots 20 to transmit the route plan. Each mobile robot 20 that has acquired the route plan starts moving toward the destination on the basis of the route plan.

In step S13, the control unit 61 of the mobile robot 20 determines whether the obstacle detection unit 62 has detected an obstacle occupying a node on the movement route. The determination processing in step S13 is repeated until it is determined that an obstacle occupying the node has been detected, and in a case where it is determined that an obstacle occupying the node has been detected, the processing proceeds from step S13 to step S14.

In step S14, the mobile robot 20 generates obstacle information that is information regarding an obstacle on the movement route, and transmits the obstacle information to the information processing apparatus 10. More specifically, the control unit 61 acquires the obstacle information supplied from the obstacle detection unit 62, and transmits the obstacle information to the information processing apparatus 10 via the communication unit 65.

In step S15, the map management unit 41 of the information processing apparatus 10 acquires the obstacle information transmitted from the mobile robot 20 and reflects the obstacle information on the route graph. That is, the map management unit 41 invalidates the node at which the obstacle is detected and updates the route graph.

In step S16, the map management unit 41 instructs the route determination unit 42 to predict the degree of influence of the newly detected obstacle on the productivity. The route determination unit 42 predicts a degree of influence of a newly detected obstacle on productivity. Specifically, the route determination unit 42 instructs the route planning unit 43 to create a route plan using a route graph updated by a new obstacle, and acquires the route plan created by the route planning unit 43. The route determination unit 42 calculates a throughput, which is an index of productivity, on the basis of a route plan using a route graph reflecting the detected new obstacle.

In step S17, the route determination unit 42 determines whether the productivity falls below the target value, specifically, whether the throughput falls below the target throughput due to the newly detected obstacle. In a case where it is determined in step S17 that the productivity does not fall below the target value, the processing in steps S18 to S25 described later is skipped. As a result, in a case where it is determined that the productivity does not fall below the target value, the processing of searching for the evacuation destination of the obstacle is not performed.

Meanwhile, in a case where it is determined in step S17 that the productivity is lower than the target value, the processing proceeds to step S18, and the route control unit 31 sets one detected obstacle as the evacuation examination target object.

Subsequently, in step S19, the route control unit 31 determines whether the evacuation examination target object can be moved to a place outside the route graph. For example, an area for placing a movable object in a place outside the route graph is determined, and it is possible to determine whether or not the evacuation examination target object can be moved to a place outside the route graph depending on the place where the evacuation examination target object is placed.

In a case where it is determined in step S19 that the evacuation examination target object can be moved to a place outside the route graph, the processing proceeds to step S20, and the route control unit 31 calculates the degree of influence on the productivity in a case where the evacuation examination target object is moved to the place outside the route graph. Thereafter, the processing proceeds to step S24.

Meanwhile, in a case where it is determined in step S19 that the evacuation examination target object cannot be moved to a place outside the route graph, the processing proceeds to step S21, and the route control unit 31 sets one of the nodes on the route graph as an evacuation candidate node of the evacuation examination target object.

In step S22, the route control unit 31 calculates the degree of influence on the productivity in a case where the evacuation examination target object is evacuated to the evacuation candidate node.

In step S23, the route control unit 31 determines whether all the evacuation candidate nodes have been examined for the evacuation examination target object, that is, whether all the available nodes on the route graph have been set as the evacuation candidate nodes. In a case where it is determined in step S23 that all the evacuation candidate nodes have not been considered for the evacuation examination target object, the processing returns to step S21. As a result, the processing in steps S21 to 23 described above is repeated, a node that has not yet been set as the evacuation candidate node is set as the next evacuation candidate node, and the degree of influence on the productivity in a case where the obstacle is evacuated to the evacuation candidate node is calculated.

Meanwhile, in a case where it is determined in step S23 that all the evacuation candidate nodes have been examined for the evacuation examination target object, the processing proceeds to step S24, and the route control unit 31 determines whether the degree of influence on the productivity has been examined for all the obstacles detected in step S13. In a case where it is determined in step S24 that all the obstacles have not been examined, the processing returns to step S18. As a result, the processing of steps S18 to 24 described above is repeated, an obstacle that has not been examined is set as the next evacuation examination target object, and the degree of influence on the productivity in a case where the obstacle is evacuated to the evacuation candidate node is calculated.

Meanwhile, in a case where it is determined in step S24 that the degree of influence on the productivity has been examined for all the obstacles detected in step S13, the processing proceeds to step S25, and the route control unit 31 determines, for each of one or more obstacles detected in step S13, the evacuation candidate node having the maximum degree of influence on the productivity as the proposed evacuation destination. The route determination unit 42 supplies the determined proposed evacuation destination to the UI unit 32 together with the degree of influence. The UI unit 32 displays the evacuation destination presentation screen and presents the evacuation destination of the obstacle to the user.

After step S25, the processing returns to step S13, and the processing of steps S13 to S25 described above is repeated.

According to the obstacle evacuation presentation processing described above, in a case where an obstacle placed on the route graph is detected, it is possible to search for and determine an evacuation destination of the obstacle that improves productivity and propose the evacuation destination to the user. Accordingly, by moving the obstacle to the evacuation destination, the user can minimize a decrease in productivity without causing the mobile robot 20 to perform bypassing or the like due to the obstacle. That is, it is possible to suppress a decrease in productivity due to obstacle avoidance.

According to the obstacle evacuation presentation processing, even in a case where an obstacle is placed on the route graph, prediction of the degree of influence on the productivity and presentation of the evacuation destination are not performed in a case where the productivity does not fall below the target value. In an environment where appearance and removal of obstacles are frequently performed, frequent suggestion of evacuation with respect to temporary obstacles includes redundancy. By presenting the evacuation destinations only when a prediction is made that the index representing the productivity falls below the target value due to the appearance of the obstacle, it is possible to reduce redundancy in which the evacuation destinations are frequently presented.

The evacuation destination presentation screen 100 illustrated in FIGS. 7 and 8 is an example in which the degree of influence in a case where the detected obstacle is moved outside the route graph (for example, outside the factory) is not displayed. In a case where it is determined that the detected obstacle is movable to a place outside the route graph and the degree of influence in that case is calculated, the degree of influence in a case where the detected obstacle is moved to a place outside the route graph can also be displayed.

### Efficient Search for Proposed Evacuation Destination

In the above-described example, in a case where the proposed evacuation destinations are determined, the route control unit 31 sequentially sets all the available nodes on the route graph as the evacuation candidate nodes and calculates the throughput to determine the proposed evacuation destinations.

However, the entire search may be difficult due to the processing capability of the information processing apparatus 10 and time restriction until the proposed evacuation destination is presented. In such a case, the route control unit 31 can adopt a method of efficiently searching for an evacuation destination by focusing on a node whose productivity is expected to be improved. For example, “Eric Ewing, et al. “Betweenness Centrality in Multi-Agent Path Finding” AAMAS '22: Proceedings of the 21st International Conference on Autonomous Agents and Multiagent Systems, pp. 400-408 (2022)” discloses a research result that movement efficiency of a route search on a route graph correlates with betweenness centrality in graph theory of each node. Therefore, the route control unit 31 extracts a plurality of nodes having low betweenness centrality, in other words, hardly affecting the transport efficiency, predicts the degree of influence on the productivity using only the extracted plurality of nodes as the evacuation candidate nodes, and determines the evacuation candidate node that improves the productivity most among the nodes as the proposed evacuation destination. As a result, the calculation amount can be reduced as compared with the full search, and the proposed evacuation destinations can be efficiently determined.

### Development to Other Than Graph Layout

The mobile robot control system 1 is configured to convert a real space in which the mobile robot 20 moves into a graph representation (route graph) including nodes and edges, determine whether or not an obstacle is placed by a node on the route graph, and present an evacuation destination. The present technology is not limited to a system using a route graph, and can also be applied to, for example, a system using a map including a passable area and a non-passable area. For example, it is possible to convert the map information of the passable area into a graph representation using a graph generation algorithm such as Delaunay triangulation. Therefore, even in a case where the real space in which the mobile robot 20 moves is expressed in any format, it is possible to convert the real space into a graph representation, quantitatively measure the influence of the obstacle on the productivity, and present the evacuation destination.

### 5. Modification of First Embodiment

In the operation of the mobile robots 20 in the mobile robot control system 1, tasks may be assigned to all the mobile robots 20, or there may be a mobile robot 20 to which a task is assigned, but there may be a mobile robot 20 that is not assigned a task and is ordered to stand by. Mobile robots 20 without task assignments may occupy nodes and prevent movement of other mobile robots 20.

In the above-described embodiment, the “obstacle” as a target for presenting the evacuation destination is, for example, an article such as cargo artificially arranged by a worker in a factory. The mobile robot 20 is an apparatus that detects an “obstacle”, and the mobile robot 20 itself is not included in the “obstacle”.

However, in other words, the “obstacle” can be generally regarded as something that can actually hinder the movement of the mobile robot 20. For example, the mobile robot 20 to which no task is assigned can also be treated as an “obstacle” in an extended manner. By treating the mobile robot 20 to which no task is assigned as an “obstacle”, the mobile robot control system 1 can perform processing of evacuating the mobile robot 20 during execution of another task to a place where the mobile robot is unlikely to interfere.

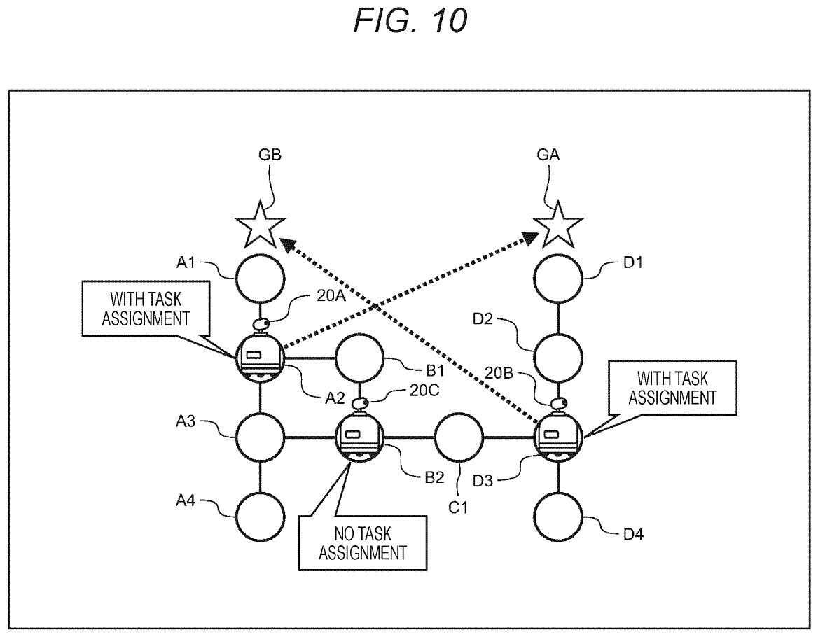

A specific example will be described with reference to FIG. 10.

A task is assigned to the mobile robot 20A, and the mobile robot 20A moves on the route graph in a direction in which the destination GA is located. A task is also assigned to the mobile robot 20B, and the mobile robot 20B moves on the route graph in a direction in which the destination GB is located. No task is assigned to the mobile robot 20C. When the mobile robot 20C is at the node B2, the mobile robot 20C obstructs the passage of the mobile robots 20A and 20B, and thus is treated as a movable obstacle.

The route control unit 31 treats the mobile robot 20C at the node B2, to which no task is assigned, as an obstacle, and determines the evacuation destinations of the mobile robot 20C by updating the route graph, evaluating the throughput (productivity), and searching for the evacuation destinations in a case where the throughput is lower than the target throughput. Similarly to the above example, in a case where the node A4 is determined as the evacuation destination of the mobile robot 20C, the route control unit 31 transmits a route plan in which the destination of the mobile robot 20C is set to the node A4 via the robot control unit 33, and moves the mobile robot 20C to the node A4 to stand by.

As described above, by treating the mobile robot 20 having no task assignment as an “obstacle”, it is possible to perform processing of evacuating the mobile robot to a place where it is unlikely for the mobile robot 20 executing another task to interfere.

Since the mobile robot 20 can be moved by the information processing apparatus 10 itself, the presentation on the evacuation destination presentation screen is not performed. Instead of displaying the evacuation destination presentation screen, the UI unit 32 can display the operation state screen of the mobile robot 20 that notifies the operation state of the mobile robot 20.

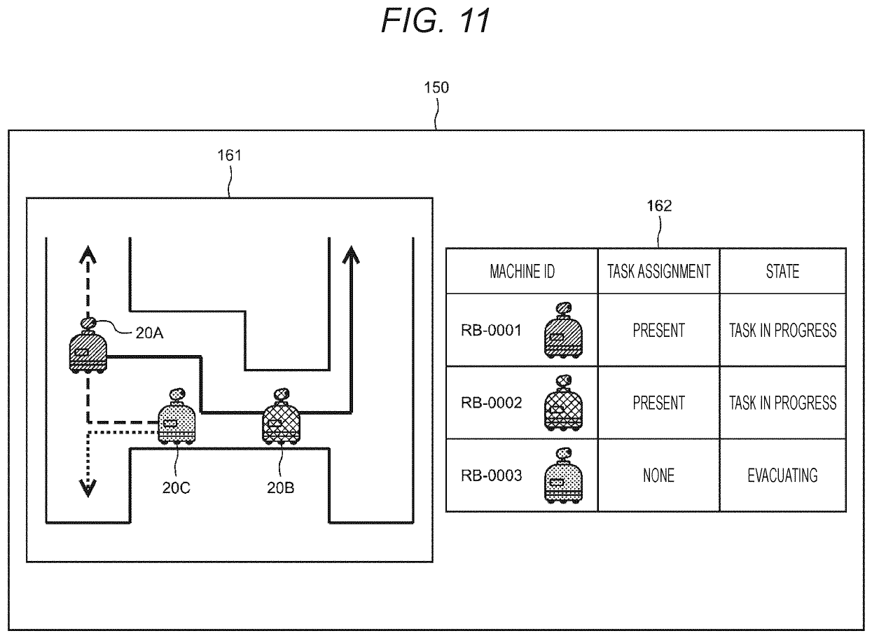

FIG. 11 illustrates an example of the operation state screen of the mobile robot 20 that notifies the operation state of the mobile robots 20A to 20C including the mobile robot 20C in evacuation.

The operation state screen 150 illustrated in FIG. 11 includes a map display unit 161 and a robot state display unit 162.

The map display unit 161 displays planned travel routes of the mobile robots 20A to 20C based on the route plan. The map display unit 161 is an example not represented by a route graph, and indicates that the control of the mobile robot 20 can be used without depending on the graph representation.

The robot state display unit 162 displays the current status of the mobile robots 20A to 20C. The robot state display unit 162 includes an item indicating a machine ID for identifying the mobile robot 20, an item indicating the presence or absence of task assignment, and an item indicating the current state (status) of the mobile robot 20. In the robot state display unit 162, the machine ID of the mobile robot 20A is “RB-0001”, the task assignment is “Present”, and the current state is “Task in progress”; the machine ID of the mobile robot 20B is “RB-0002”, the task assignment is “Present”, and the current state is “Task in progress”; and the machine ID of the mobile robot 20C is “RB-0003”, the task assignment is “None”, and the current state is “Evacuating”.

The images (icons) corresponding to the mobile robots 20A to 20C are displayed so as to be distinguishable by, for example, adding different colors depending on the presence or absence of task assignment, changing patterns, changing registered images, or the like, and the display of the map display unit 161 and the robot state display unit 162 also correspond. The mobile robots 20 may be identifiably displayed by displaying robot names and machine IDs on images of the mobile robots 20A to 20C.

### 6. Second Embodiment of Mobile Robot Control System

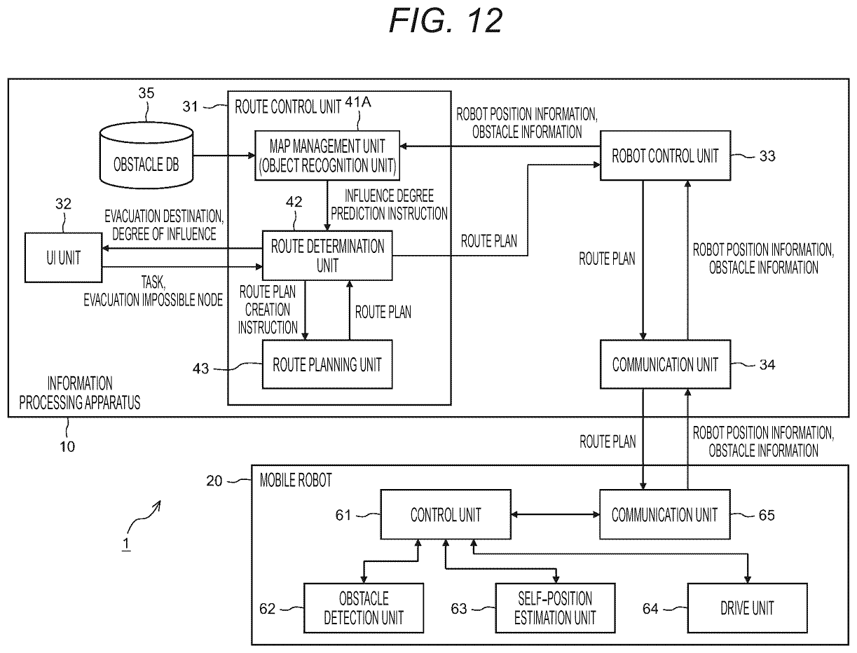

FIG. 12 is a block diagram illustrating a configuration example of a second embodiment of a mobile robot control system which is an information processing system of the present disclosure.

In the mobile robot control system 1 illustrated in FIG. 12, portions corresponding to those of the first embodiment illustrated in FIG. 4 are denoted by the same reference signs. In the second embodiment, description overlapping with the first embodiment will be omitted, and description will be given focusing on a part different from the first embodiment.

In the above-described first embodiment, in a case where an obstacle is detected, the information processing apparatus 10 cannot determine whether or not the obstacle is an object suitable for presenting an evacuation destination. For example, there may be a case where a state where a group of people is working at a certain node is detected as being occupied by an obstacle and transmitted to the information processing apparatus 10. In a case where human manual work is temporary, occupation of a node is automatically resolved over time. The mobile robot 20 detects a state in which a group of people is working as being occupied by an obstacle and transmits the state to the information processing apparatus 10, and the information processing apparatus 10 predicts the degree of influence on the productivity of the obstacle. However, when the occupation of the node is automatically resolved with the lapse of time, the effect of presenting the evacuation destination to the user is reduced.

Therefore, in the mobile robot control system 1 according to the second embodiment, the information processing apparatus 10 acquires a captured image obtained by capturing an obstacle from the mobile robot 20, executes object recognition processing for the obstacle using the captured image, and specifies the type of the obstacle, thereby determining the necessity of productivity evaluation and evacuation destination presentation. The information processing apparatus 10 includes a database in which the type of the obstacle is associated with necessity of presentation of the evacuation destination, and determines necessity of presentation of the evacuation destination with reference to the database.

Comparing the configuration of the second embodiment in FIG. 12 with the configuration of the first embodiment illustrated in FIG. 4, the information processing apparatus 10 is newly provided with an obstacle DB 35 in addition to the route control unit 31, the UI unit 32, the robot control unit 33, and the communication unit 34. In addition, the map management unit 41 of the route control unit 31 in the first embodiment is changed to a map management unit 41A.

In the first embodiment, in a case where an obstacle on the movement route is detected, the mobile robot 20 transmits obstacle information to the information processing apparatus 10. The obstacle information includes the position information of the obstacle. In the second embodiment, the obstacle information transmitted from the mobile robot 20 to the information processing apparatus 10 includes a captured image obtained by imaging the obstacle in addition to the position information of the obstacle. For example, in a case where the obstacle detection unit 62 includes a stereo camera, a captured image of an obstacle captured by one of the two imaging sensors included in the stereo camera is transmitted as a part of the obstacle information. In a case where obstacle detection unit 62 does not include an imaging sensor, an imaging sensor for imaging an obstacle may be provided.

The obstacle DB 35 includes a database in which the type of the obstacle is associated with necessity of presentation of the evacuation destination. For example, the obstacle DB 35 stores the name of an object that can be an obstacle and the necessity of the evacuation destination search processing in association with each other. For example, in a case where the object detected as the obstacle is a person, the evacuation destination search processing is not performed, and in a case where the object detected as the obstacle is cargo (cardboard), the evacuation destination search processing is performed. In the obstacle DB 35, only objects for which the evacuation destination search processing does not need to be performed may be registered, or only objects for which the evacuation destination search processing is performed may be registered.

In a case of acquiring the obstacle information including at least the position information of the obstacle and the captured image obtained by imaging the obstacle from the robot control unit 33, the map management unit 41A executes the object recognition processing using the captured image. By the object recognition processing, the object of the obstacle in the captured image is detected, and the name of the object is identified. For example, the map management unit 41A identifies the name of the object such as whether the object detected as the obstacle is a person who is working, cargo, or the mobile robot 20. For such object recognition processing, a known image processing technique can be adopted. In recent years, object recognition processing of classifying an object from an RGB image and outputting a name of the object with high accuracy and high detection capability has been disclosed.

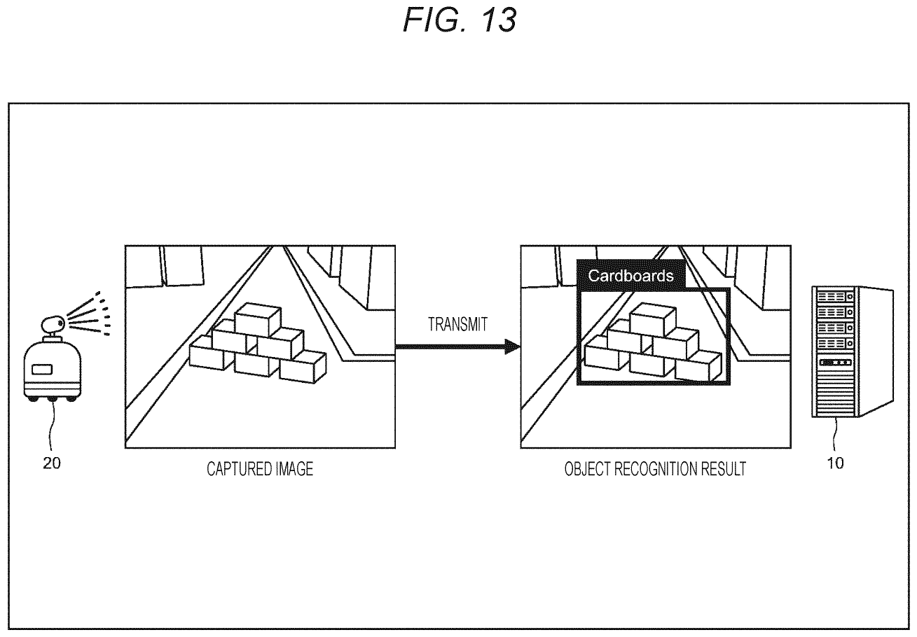

FIG. 13 illustrates an example in which the object recognition processing is executed on the captured image transmitted from the mobile robot 20. As a result of the object recognition processing, it is recognized that the detected obstacle is cargo (a plurality of pieces of cardboard).

The map management unit 41A refers to the obstacle DB 35 and determines whether or not the object identified by the object recognition processing is an object for which the evacuation destination search processing is performed. For example, in the obstacle DB 35, it is stored to perform evacuation destination search processing in the case of cargo (cardboard), and the map management unit 41A determines to perform the evacuation destination search processing and instructs the route determination unit 42 to predict the degree of influence of the obstacle on productivity. The procedure of predicting the degree of influence is similar to that of the first embodiment described above. Meanwhile, in a case of determining that the evacuation destination search processing is unnecessary, the map management unit 41A does not instruct the route determination unit 42 to predict the degree of influence of the obstacle on the productivity. Therefore, the evacuation destination presentation screen is not displayed on the UI unit 32.

### 7. Flowchart of Evacuation Destination Search Necessity Determination Processing

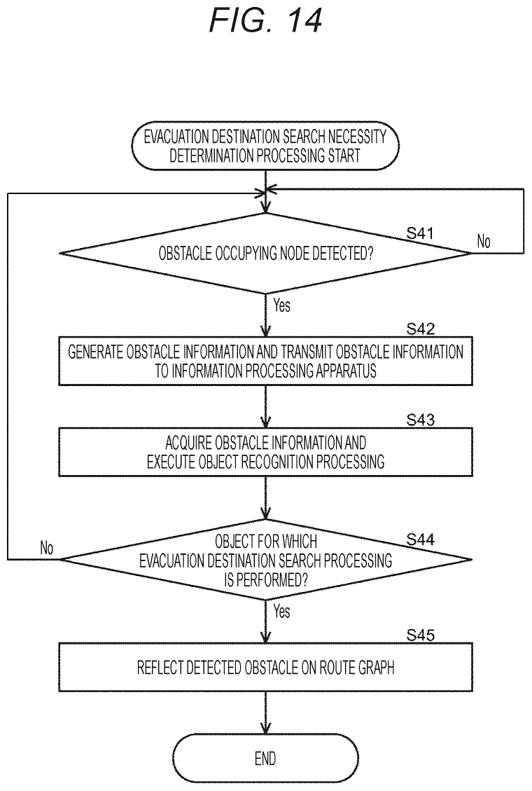

With reference to the flowchart of FIG. 14, evacuation destination search necessity determination processing for determining whether or not to perform evacuation destination search processing will be described.

The evacuation destination search necessity determination processing of FIG. 14 corresponds to a part of the obstacle evacuation presentation processing of FIG. 9 in the first embodiment. Specifically, the mobile robot control system 1 can execute the obstacle evacuation presentation processing in FIG. 9 by replacing the processing in steps S13 to S15 in FIG. 9 with the processing in steps S41 to S45 in FIG. 14.

In step S41, the control unit 61 of the mobile robot 20 determines whether the obstacle detection unit 62 has detected an obstacle occupying a node on the movement route. The determination processing in step S41 is repeated until it is determined that an obstacle occupying the node has been detected, and in a case where it is determined that an obstacle occupying the node has been detected, the processing proceeds from step S41 to step S42.

In step S42, the mobile robot 20 generates obstacle information that is information regarding an obstacle on the movement route, and transmits the obstacle information to the information processing apparatus 10. The obstacle information includes at least position information of the obstacle and a captured image of the obstacle.

In step S43, the map management unit 41 of the information processing apparatus 10 acquires the obstacle information transmitted from the mobile robot 20, and executes the object recognition processing using the captured image. By the object recognition processing, the object of the obstacle in the captured image is detected, and the name of the object is identified.

In step S44, the map management unit 41A refers to the obstacle DB 35 and determines whether or not the object identified by the object recognition processing is an object for which the evacuation destination search processing is to be performed. In a case where it is determined in step S44 that the object identified by the object recognition processing is not the object for which the evacuation destination search processing is to be performed, the processing returns to step S41. Therefore, in a case where the object is not the object for which the evacuation destination search processing is performed, the degree of influence of the obstacle on the productivity is not predicted, and the evacuation destination presentation screen is not displayed.

Meanwhile, in a case where it is determined in step S44 that the object identified by the object recognition processing is an object for which the evacuation destination search processing is to be performed, the processing proceeds to step S45, and the map management unit 41A reflects the obstacle detected by the mobile robot 20 on the route graph. Specifically, the map management unit 41A invalidates the node at which the obstacle is detected and updates the route graph. Thereafter, the processing proceeds to step S16 of FIG. 9, and the map management unit 41A instructs the route determination unit 42 to predict the degree of influence of the newly detected obstacle on the productivity.

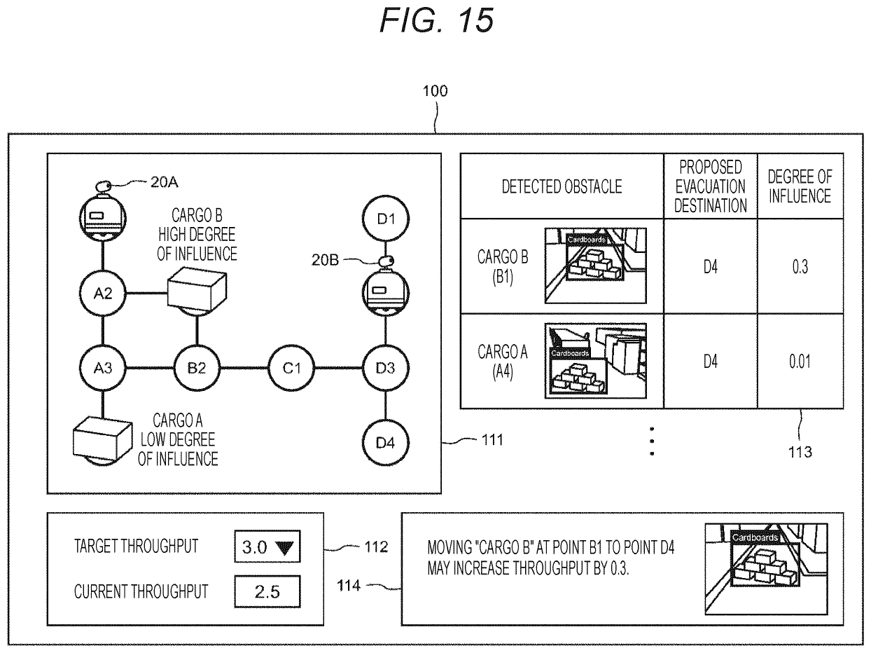

FIG. 15 illustrates an example of an evacuation destination presentation screen according to the second embodiment.

The evacuation destination presentation screen 100 in FIG. 15 corresponds to the evacuation destination presentation screen 100 in FIG. 7 in the first embodiment, and a portion changed from the evacuation destination presentation screen 100 in FIG. 7 will be described. On the evacuation destination presentation screen 100 according to the second embodiment, the evacuation destination of the detected obstacle is presented using the name of the object identified by the object recognition processing and the captured image.

The evacuation destination presentation screen 100 of FIG. 15 illustrates an example in a case where “cargo B” placed on the node B1 and “cargo A” placed on the node A4 are detected.

In the route graph display unit 111, names of objects identified by object recognition, such as “cargo B” for the obstacle detected at the node B1 and “cargo A” for the obstacle detected at the node A4, are attached. In addition, the display of the plurality of detected obstacles is distinguished by the magnitude of the degree of influence on the productivity in the case of evacuation. For example, the color or pattern of an object image displayed in the vicinity of an obstacle such as “high influence degree” or “low influence degree” or displayed on a node is distinguished by the magnitude of the influence degree. The image of the obstacle placed on the node may be an icon image stored in advance in the obstacle DB 35, or a captured image obtained by imaging the obstacle by the mobile robot 20 may be used. The node of the proposed evacuation destination of the detected obstacle may be displayed in different colors, patterns, the like to display the proposed evacuation destination to the user in an easy-to-understand manner.

The proposed evacuation destination display unit 113 displays the detected obstacles, the proposed evacuation destination, and the degree of influence in a case where the obstacles are evacuated to the proposed evacuation destination in descending order of the degree of influence for the plurality of detected obstacles. In the item of the detected obstacle, the name of the identified object is displayed, and a captured image obtained by imaging the obstacle by the mobile robot 20 is displayed. Specifically, for the obstacle detected at the node B1, the name “cargo B” of the object is displayed, the node “D4” is displayed as the proposed evacuation destination, and “0.3” is displayed as the degree of influence in a case where the obstacle is evacuated to the node D4. For the obstacle detected by the node A4, the name of the object “cargo A” is displayed, the node “D4” is displayed as the proposed evacuation destination, and “0.01” is displayed as the degree of influence in a case where the obstacle is evacuated to the node D4.

On the comment display unit 114, a comment of “Moving “cargo B” at point B1 to point D4 may increase the throughput by 0.3.” is displayed, and a captured image obtained by imaging the obstacle is displayed. The comment of the comment display unit 114 is also displayed using the name of the identified object.

The evacuation destination presentation screen 100 in FIG. 15 illustrates an example in which, in a case where a plurality of obstacles is detected, the proposed evacuation destination and the degree of influence of evacuation to the proposed evacuation destination are presented for all the detected obstacles. However, only for an obstacle whose degree of influence is expected to be improved by a predetermined value or more determined in advance, the proposed evacuation destination and the degree of influence in a case where the obstacle is evacuated to the proposed evacuation destination may be presented. For example, if it is assumed that the evacuation destination is presented only in a case where the degree of influence is 0.2 or more, the proposed evacuation destination for “cargo B” is displayed but the proposed evacuation destination for “cargo A” is not displayed in the proposed evacuation destination display unit 113.

### 8. Graph Layout Change Presentation Function Using Object Recognition Processing

Next, a graph layout change presentation function using the object recognition processing will be described.

In the second embodiment described above, in a case where the mobile robot 20 detects an obstacle, the obstacle information including a captured image obtained by capturing the obstacle is transmitted to the information processing apparatus 10, the object recognition processing is executed on the captured image in the information processing apparatus 10, and an object of the obstacle is identified.

That is, in the above-described example, the mobile robot 20 transmits the captured image to the information processing apparatus 10 only in a case where an obstacle is detected. However, regardless of the presence or absence of the obstacle detection, a captured image obtained by capturing an environment around the apparatus captured during movement may be transmitted to the information processing apparatus 10.

The information processing apparatus 10 can execute the object recognition processing using the captured image transmitted from the mobile robot 20, identify a movable object arranged in an area other than the currently set route graph, and suggest the user to move the object.

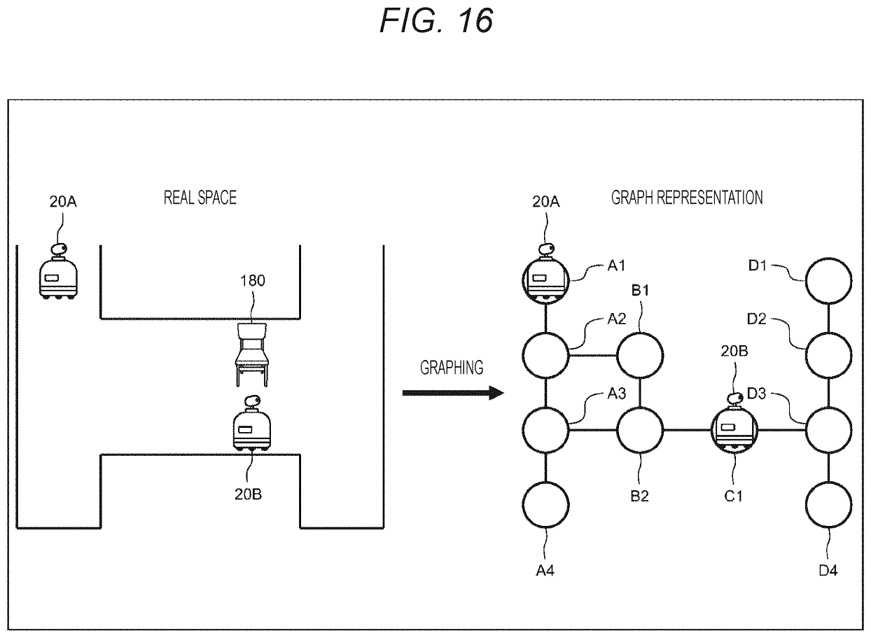

FIG. 16 illustrates an example of conversion from a real space in a factory to a route graph performed at the start of system operation.

When creating a route graph for the mobile robot 20, the designer performs graph design assuming that the chairs 180 arranged at predetermined places in the factory do not move. Such a graph layout is subjectively determined by human intervention, but if the chair 180 can be moved, productivity may be further improved.

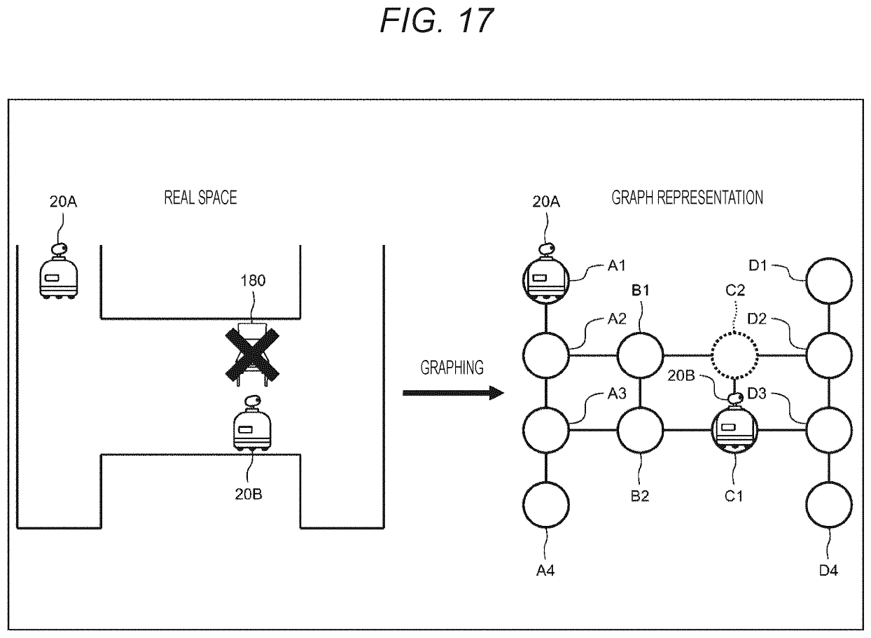

FIG. 17 illustrates an example of a route graph in a case where the chair 180 can be moved.

In a case where the chair 180 can be moved, a node C2 can be newly added. With the addition of the node C2, for example, in a case where the mobile robot 20 desires to move from the node B1 to the node D2, a movement route of the node B1 to the node C2 to the node D2 is possible in addition to the movement route of the node B1 to the node B2 to the node C1 to the node D3 to the node D2, and the movement distance is also shortened, so that improvement in productivity is expected. If productivity can be increased, it is useful to present the possibility of route graph expansion to the user.

The configuration of each unit in a case where the graph layout change presentation function is executed will be described with reference to the block diagram of the second embodiment illustrated in FIG. 12.

The mobile robot 20 transmits a captured image obtained by capturing the surroundings including the outside of the route graph during movement to the information processing apparatus 10 regardless of the presence or absence of obstacle detection. In a case of detecting an obstacle, the mobile robot 20 transmits obstacle information including position information of the obstacle and a captured image of the obstacle, and in a case of not detecting an obstacle, the mobile robot transmits only the captured image.

The map management unit 41A acquires the captured image transmitted from the mobile robot 20 via the robot control unit 33, refers to the image of the object stored in the obstacle DB 35, and executes the object recognition processing on the captured image. By the object recognition processing, it is determined whether or not there is an object in the captured image and the object is an object movable outside the route graph. In a case where it is determined that the object in the captured image is a movable object, the map management unit 41A instructs the route determination unit 42 to predict the degree of influence on the productivity in a case where the detected object is moved. More specifically, the map management unit 41A assumes that the detected object has moved, creates a temporary route graph to which a node has been added, and instructs the route determination unit 42 to predict the degree of influence on productivity.

The route determination unit 42 predicts the degree of influence on the productivity in a case where the detected object is moved. How much productivity (throughput) is improved in a case where the detected object is moved is calculated. In a case where improvement in productivity is expected in a case where the detected object is moved, the route determination unit 42 determines a proposal for the object movement. The route determination unit 42 supplies the object movement proposal instruction to the UI unit 32. The UI unit 32 displays an object movement presentation screen that proposes the movement of the detected object. The UI unit 32 functions as a presentation unit that presents layout change due to object movement. The user can determine whether or not to move the presented object with reference to the object movement presentation screen displayed on the UI unit 32.

### 9. Flowchart of Layout Change Presentation Processing

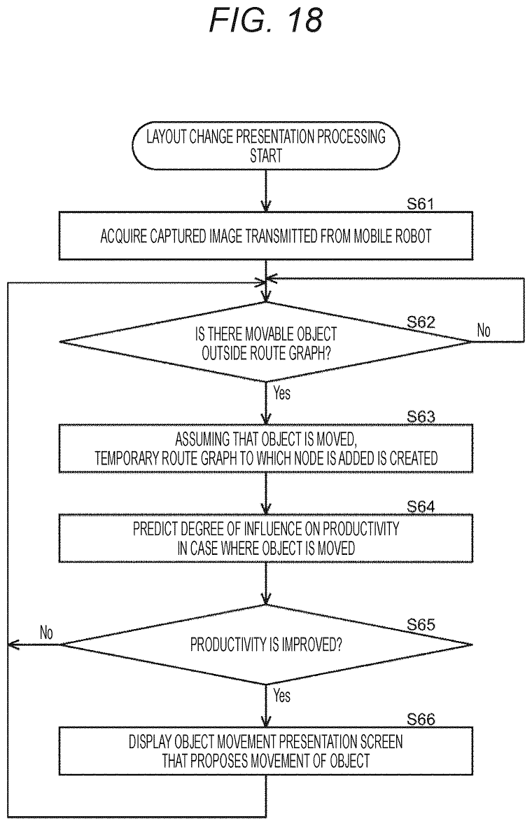

Layout change presentation processing of detecting a movable object outside the route graph and presenting a layout change will be described with reference to a flowchart of FIG. 18. This processing can be started simultaneously with the above-described obstacle evacuation presentation processing, and can be executed in parallel with the obstacle evacuation presentation processing.

First, in step S61, the map management unit 41A of the information processing apparatus 10 acquires the captured image transmitted from the mobile robot 20 via the robot control unit 33.

In step S62, the map management unit 41A refers to the image of the object stored in the obstacle DB 35, executes the object recognition processing on the captured image, and determines whether there is a movable object at a position outside the route graph. The processing in step S62 is repeated until it is determined in step S62 that there is a movable object, and in a case where it is determined in step S62 that there is a movable object, the processing proceeds to step S63.

In step S63, the map management unit 41A assumes that the detected object has moved, and creates a temporary route graph to which a node has been added.

In step S64, the map management unit 41A instructs the route determination unit 42 to predict the degree of influence on the productivity in a case where the detected object is moved. The route determination unit 42 predicts the degree of influence on the productivity in a case where the object is moved using the temporary route graph. Specifically, the route determination unit 42 instructs the route planning unit 43 to create a route plan using the temporary route graph, and acquires the created route plan from the route planning unit 43. The route determination unit 42 calculates a throughput, which is an index of productivity, on the basis of the route plan using the temporary route graph.

In step S65, the route determination unit 42 determines whether productivity is improved in a case where the detected object is moved on the basis of the prediction result of the degree of influence. In a case where it is determined in step S65 that the productivity is not improved, the processing returns to step S62, and the above-described processing is repeated.

Meanwhile, in a case where it is determined in step S65 that the productivity is improved, the processing proceeds to step S66, and the route determination unit 42 determines a proposal for the movement of the detected object and supplies a proposal instruction for the object movement to the UI unit 32. The UI unit 32 displays an object movement presentation screen that proposes the movement of the detected object. Thereafter, the processing returns to step S62 again, and the above-described processing is repeated.

As described above, according to the layout change presentation processing, it is possible to detect a movable object placed at a position outside the route graph and suggest the movement to the user. The user can determine whether or not to move the presented object with reference to the object movement presentation screen displayed on the UI unit 32. The UI unit 32 functions as a presentation unit that presents layout change due to object movement. In a case where the object can be moved, the route graph can be expanded, and productivity can be further improved.

### 10. Modification of Second Embodiment

In the second embodiment described above, the captured image captured by the mobile robot 20 is transmitted to the information processing apparatus 10, and the information processing apparatus 10 executes the object recognition processing for the obstacle using the captured image, and specifies the type of the obstacle and identifies the movable object. However, the mobile robot 20 itself may have an object recognition function, an object such as a captured obstacle may be specified, and a name and an image of the specified object may be transmitted to the information processing apparatus 10.

### 11. Summary

In the mobile robot control system 1 described above, the obstacle detection unit 62 of the mobile robot 20 detects a movable object arranged on the route as an obstacle, and the communication unit 65 transmits obstacle information indicating that the obstacle has been detected to the information processing apparatus 10. The map management unit 41 of the information processing apparatus 10 acquires, from the mobile robot 20, obstacle information indicating that a movable object disposed on the route of the mobile robot 20 has been detected as an obstacle. The route determination unit 42 determines the evacuation destination of the obstacle on the basis of productivity in a case where the obstacle is evacuated to a predetermined place. The UI unit 32 presents the determined evacuation destination of the obstacle to the user by displaying the evacuation destination presentation screen. The information processing apparatus 10 can quantitatively evaluate the influence of the bottleneck caused by the obstacle on the productivity by calculating the degree of influence on the productivity. By proposing an action that can be performed by the user side for improving productivity, it is possible to suppress a decrease in productivity. It is possible to promote the user to understand which node is occupied to reduce productivity.

In the second embodiment, the map management unit 41 acquires a captured image of the detected obstacle, and executes object recognition processing to specify the type of the obstacle, thereby determining the necessity of productivity evaluation and evacuation destination presentation. In a case where the obstacle is an object that is not assumed to be moved, such as a case where the obstacle is a person who is working, it is possible to perform control so as not to perform productivity evaluation and evacuation destination presentation, and to avoid redundancy.

In addition, in the second embodiment, the map management unit 41 acquires a captured image obtained by capturing the surroundings including the outside of the route graph, and executes the object recognition processing to specify the type of the obstacle, so that it is possible to propose the movement of the object that can expand the route graph. In a case where the object can be moved, the route graph can be expanded, and productivity can be further improved.

### 12. Configuration Example of Hardware of Computer

The processing executed by the information processing apparatus 10 and the control processing of the mobile robot 20 described above can be executed by hardware or software. In a case where the series of processing is executed by software, a program constituting the software is installed in a computer. Here, the computer includes a microcomputer incorporated in dedicated hardware, a general-purpose personal computer capable of executing various functions by installing various programs, and the like, for example.

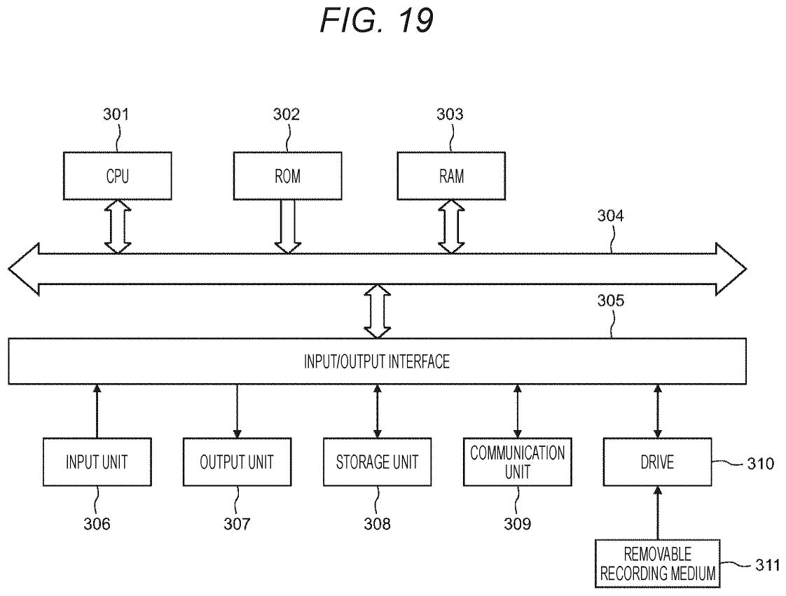

FIG. 19 is a block diagram illustrating a configuration example of hardware of a computer that executes processing executed by the information processing apparatus 10 or the mobile robot 20 by a program.

In the computer, a central processing unit (CPU) 301, a read only memory (ROM) 302, and a random access memory (RAM) 303 are mutually connected by a bus 304.

An input/output interface 305 is further connected to the bus 304. An input unit 306, an output unit 307, a storage unit 308, a communication unit 309, and a drive 310 are connected to the input/output interface 305.

The input unit 306 includes a keyboard, a mouse, a microphone, a touch panel, an input terminal, and the like. The output unit 307 includes a display, a speaker, an output terminal, and the like. The storage unit 308 includes a hard disk, a solid state drive (SSD), a RAM disk, a nonvolatile memory, and the like. The communication unit 309 includes a network interface and the like. The drive 310 drives a removable recording medium 311 such as a magnetic disk, an optical disk, a magneto-optical disk, or a semiconductor memory.

In the computer configured as described above, for example, the CPU 301 loads a program stored in the storage unit 308 into the RAM 303 via the input/output interface 305 and the bus 304 and executes the program, whereby the above-described series of processing is performed. The RAM 303 also appropriately stores data and the like necessary for the CPU 301 to execute various processes.

The program executed by the computer (CPU 301) can be provided by being recorded in the removable recording medium 311 as a package medium or the like, for example. Furthermore, the program can be provided via a wired or wireless transmission medium such as a local area network, the Internet, or digital satellite broadcasting.

In the computer, the program can be installed in the storage unit 308 via the input/output interface 305 by attaching the removable recording medium 311 to the drive 310. Furthermore, the program can be received by the communication unit 309 via a wired or wireless transmission medium and installed in the storage unit 308. In addition, the program can be installed in the ROM 302 or the storage unit 308 in advance.

Note that, in the present specification, the steps described in the flowcharts may be performed not only in chronological order according to the described order, but also in parallel or at necessary timing such as in a case where a call is made, without being necessarily processed in chronological order.

In the present specification, a system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

The embodiments of the present disclosure are not limited to the above-described embodiments, and various modifications can be made without departing from the gist of the technology of the present disclosure. For example, a form in which some of the above-described embodiments are appropriately combined can be adopted.

For example, the technology of the present disclosure can have a configuration of cloud computing in which one function is shared and processed in cooperation by a plurality of apparatuses via a network.

Each step described in the above-described flowcharts can be executed by one apparatus or can be shared and executed by a plurality of apparatuses. Furthermore, in a case where a plurality of processes is included in one step, the plurality of processes included in the one step can be executed by one apparatus or can be shared and executed by a plurality of apparatuses.

Note that the effects described in the present specification are merely examples and are not limited, and effects other than those described in the present specification may be provided.

Note that the technology of the present disclosure can have the following configurations.
(1)
An information processing method including:
acquiring obstacle information indicating that a movable object arranged on a route of a mobile body is detected as an obstacle;
searching and determining an evacuation destination of the obstacle on the basis of productivity in a case where the obstacle is evacuated to a predetermined place; and
presenting a determined evacuation destination of the obstacle.
(2)
The information processing method according to (1), further including
updating a route graph corresponding to the route on the basis of the obstacle information acquired, predicting productivity in a case where there is the obstacle using the route graph updated, and searching and determining an evacuation destination of the obstacle in a case where the productivity falls below a target value.
(3)
The information processing method according to (1) or (2), further including
updating a route graph corresponding to the route on the basis of the obstacle information acquired, predicting productivity in a case where there is the obstacle using the route graph updated, and not searching for an evacuation destination of the obstacle in a case where the productivity does not fall below a target value.
(4)
The information processing method according to any one of (1) to (3), further including
predicting productivity in a case where the obstacle is evacuated to the predetermined place, and determining the predetermined place where a change amount in productivity is maximum as an evacuation destination of the obstacle.
(5)
The information processing method according to any one of (1) to (4), in which
the obstacle information includes position information of the obstacle.
(6)
The information processing method according to any one of (1) to (5), further including
predicting productivity in a case where the obstacle is evacuated to an outside of the route and presenting the outside of the route as one of evacuation destinations of the obstacle.
(7)
The information processing method according to any one of (1) to (6), further including
presenting the evacuation destination determined of the obstacle and a degree of influence of productivity in a case where the obstacle is evacuated to the evacuation destination.
(8)
The information processing method according to any one of (1) to (7), in which
whether or not the evacuation destination on the route is available can be input.
(9)
The information processing method according to any one of (1) to (8), further including
extracting a plurality of the predetermined place having low betweenness centrality, predicting productivity using only the plurality of the predetermined place extracted as evacuation candidate places, and searching and determining an evacuation destination of the obstacle.
(10)
The information processing method according to any one of (1) to (9), in which
the obstacle includes the mobile body to which no task is assigned.
(11)
The information processing method according to (10), further including:
searching and determining an evacuation destination of the mobile body to which the task is not assigned; and
moving the mobile body to which the task is not assigned to the evacuation destination determined.
(12)
The information processing method according to any one of (1) to (11), further including
presenting an operation state of the mobile body, and distinguishing and presenting the mobile body depending on whether or not a task is assigned.
(13)
The information processing method according to any one of (1) to (12), in which
the obstacle information includes position information of the obstacle and a captured image of the obstacle, and
object recognition processing is executed using the captured image, and an object of the obstacle is identified.
(14)
The information processing method according to (13), further including
determining whether the object identified by the object recognition processing is an object for which evacuation destination search processing of searching for an evacuation destination of the obstacle is performed, and searching and determining an evacuation destination of the obstacle in a case where the object is an object for which the evacuation destination search processing is performed.
(15)
The information processing method according to (13) or (14), further including
presenting the evacuation destination of the obstacle by using a name of the object identified by the object recognition processing and the captured image.
(16)
The information processing method according to any one of (1) to (15), further including:
acquiring a captured image obtained by capturing an outside of the route of the mobile body; and
executing object recognition processing by using the captured image outside the route, determining whether there is a movable object outside the route, and proposing movement of the object in a case where there is the movable object.
(17)
The information processing method according to any one of (1) to (16), in which
the obstacle for which the evacuation destination is presented is distinguished by a magnitude of a degree of influence on the productivity.
(18)
An information processing apparatus including:
an acquisition unit that acquires obstacle information indicating that a movable object arranged on a route of a mobile body is detected as an obstacle;
a determination unit that searches and determines an evacuation destination of the obstacle on the basis of productivity in a case where the obstacle is evacuated to a predetermined place; and
a presentation unit that presents a determined evacuation destination of the obstacle.
(19)
A program for causing a computer to execute processing of:
acquiring obstacle information indicating that a movable object arranged on a route of a mobile body is detected as an obstacle;
searching and determining an evacuation destination of the obstacle on the basis of productivity in a case where the obstacle is evacuated to a predetermined place; and
presenting a determined evacuation destination of the obstacle.
(20)
An information processing system including:
an information processing apparatus and a mobile body, in which
the mobile body includes:
a detection unit that detects a movable object disposed on a route of the mobile body as an obstacle; and
a transmission unit that transmits obstacle information indicating that the obstacle has been detected,
and
the information processing apparatus includes:
an acquisition unit that acquires the obstacle information;
a determination unit that searches and determines an evacuation destination of the obstacle on the basis of productivity in a case where the obstacle is evacuated to a predetermined place; and
a presentation unit that presents a determined evacuation destination of the obstacle.

### REFERENCE SIGNS LIST

1 Mobile robot control system
10 Information processing apparatus
20, 20A, 20B, 20C Mobile robot
31 Route control unit
32 UI unit
33 Robot control unit
34 Communication unit
41, 41A Map management unit
42 Route determination unit
43 Route planning unit
61 Control unit
62 Obstacle detection unit
63 Self-position estimation unit
64 Drive unit
65 Communication unit
100 Evacuation destination presentation screen
111 Route graph display unit
112 Throughput display unit
113 Proposed evacuation destination display unit
114 Comment display unit
150 Operation state screen
161 Map display unit
162 Robot state display unit
301 CPU
302 ROM
303 RAM
306 Input unit
307 Output unit
308 Storage unit
309 Communication unit
310 Drive

1. An information processing method comprising:
acquiring obstacle information indicating that a movable object arranged on a route of a mobile body is detected as an obstacle;
searching and determining an evacuation destination of the obstacle on a basis of productivity in a case where the obstacle is evacuated to a predetermined place; and
presenting a determined evacuation destination of the obstacle.

2. The information processing method according to claim 1, further comprising
updating a route graph corresponding to the route on a basis of the obstacle information acquired, predicting productivity in a case where there is the obstacle using the route graph updated, and searching and determining an evacuation destination of the obstacle in a case where the productivity falls below a target value.

3. The information processing method according to claim 1, further comprising
updating a route graph corresponding to the route on a basis of the obstacle information acquired, predicting productivity in a case where there is the obstacle using the route graph updated, and not searching for an evacuation destination of the obstacle in a case where the productivity does not fall below a target value.

4. The information processing method according to claim 1, further comprising
predicting productivity in a case where the obstacle is evacuated to the predetermined place, and determining the predetermined place where a change amount in productivity is maximum as an evacuation destination of the obstacle.

5. The information processing method according to claim 1, wherein
the obstacle information includes position information of the obstacle.

6. The information processing method according to claim 1, further comprising
predicting productivity in a case where the obstacle is evacuated to an outside of the route and presenting the outside of the route as one of evacuation destinations of the obstacle.

7. The information processing method according to claim 1, further comprising
presenting the evacuation destination determined of the obstacle and a degree of influence of productivity in a case where the obstacle is evacuated to the evacuation destination.

8. The information processing method according to claim 1, wherein
whether or not the evacuation destination on the route is available can be input.

9. The information processing method according to claim 1, further comprising
extracting a plurality of the predetermined place having low betweenness centrality, predicting productivity using only the plurality of the predetermined place extracted as evacuation candidate places, and searching and determining an evacuation destination of the obstacle.

10. The information processing method according to claim 1, wherein
the obstacle includes the mobile body to which no task is assigned.

11. The information processing method according to claim 10, further comprising:
searching and determining an evacuation destination of the mobile body to which the task is not assigned; and
moving the mobile body to which the task is not assigned to the evacuation destination determined.

12. The information processing method according to claim 1, further comprising
presenting an operation state of the mobile body, and distinguishing and presenting the mobile body depending on whether or not a task is assigned.

13. The information processing method according to claim 1, wherein
the obstacle information includes position information of the obstacle and a captured image of the obstacle, and
object recognition processing is executed using the captured image, and an object of the obstacle is identified.

14. The information processing method according to claim 13, further comprising
determining whether the object identified by the object recognition processing is an object for which evacuation destination search processing of searching for an evacuation destination of the obstacle is performed, and searching and determining an evacuation destination of the obstacle in a case where the object is an object for which the evacuation destination search processing is performed.

15. The information processing method according to claim 13, further comprising
presenting the evacuation destination of the obstacle by using a name of the object identified by the object recognition processing and the captured image.

16. The information processing method according to claim 1, further comprising:
acquiring a captured image obtained by capturing an outside of the route of the mobile body; and
executing object recognition processing by using the captured image outside the route, determining whether there is a movable object outside the route, and proposing movement of the object in a case where there is the movable object.

17. The information processing method according to claim 1, wherein
the obstacle for which the evacuation destination is presented is distinguished by a magnitude of a degree of influence on the productivity.

18. An information processing apparatus comprising:
an acquisition unit that acquires obstacle information indicating that a movable object arranged on a route of a mobile body is detected as an obstacle;
a determination unit that searches and determines an evacuation destination of the obstacle on a basis of productivity in a case where the obstacle is evacuated to a predetermined place; and
a presentation unit that presents a determined evacuation destination of the obstacle.

19. A program for causing a computer to execute processing of:
acquiring obstacle information indicating that a movable object arranged on a route of a mobile body is detected as an obstacle;
searching and determining an evacuation destination of the obstacle on a basis of productivity in a case where the obstacle is evacuated to a predetermined place; and
presenting a determined evacuation destination of the obstacle.

20. An information processing system comprising:
an information processing apparatus and a mobile body, wherein
the mobile body includes:
a detection unit that detects a movable object disposed on a route of the mobile body as an obstacle; and
a transmission unit that transmits obstacle information indicating that the obstacle has been detected,
and
the information processing apparatus includes:
an acquisition unit that acquires the obstacle information;
a determination unit that searches and determines an evacuation destination of the obstacle on a basis of productivity in a case where the obstacle is evacuated to a predetermined place; and
a presentation unit that presents a determined evacuation destination of the obstacle.
